(19) United States
(12) Patent Application Publication
(10) Pub. No.: US 2003/0110170 A1
(43) Pub. Date: Jun. 12, 2003

(54) Delivery noticing method, delivery noticing system, central apparatus, server computer and recording medium

(75) Inventor: Shinichi Matsuoka, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/270,133

(22) Filed: Oct. 15, 2002

(30) Foreign Application Priority Data
Dec. 7, 2001 (JP) 2001-374874
Apr. 25, 2002 (JP) 2002-124926

(51) Int. Cl. G06F 7/00

(52) U.S. Cl. 707/9

(57) ABSTRACT

Provided is a delivery noticing system which can give a previous notice of delivery to a receiver, without notifying a delivery company of the receiver's communication address. A receiver is stored in advance in a provider database in relation to a provider used by the receiver. A central apparatus 1 accepts information related to the delivery of the receiver, retrieves the provider used by the receiver from provider database, and generates delivery noticing information based on the information related to the delivery. The central apparatus 1 transmits the generated delivery noticing information with information on the receiver to a server computer 2 of the retrieved provider. The server computer 2 retrieves a communication address from address database based on the transmitted information on the receiver, and transmits the transmitted delivery noticing information to the retrieved communication address.

### BACKGROUND OF THE INVENTION

1. Field of the Invention

The present invention relates to a delivery noticing method and a delivery noticing system for giving a previous notice of delivery to a receiver, who receives a delivery, through a central apparatus for managing information related to the delivery including information on the receiver and a plurality of server computers of service providers, to a central apparatus and a server computer constituting the delivery noticing system and to a recording medium. In particular, the invention relates to a delivery noticing method and the like with which the receiver can receive delivery noticing information without notifying a delivery company of his communication address such as his electronic mail address or his telephone number.

2. Description of Related Art

A customer of a shop often requests a delivery company to deliver his purchase after shopping if his purchase is bulky or does not exist in the shop. Since there are many cases where the purchased goods are delivered in the receiver's absence, systems have been proposed for sending an electronic mail for giving a notice of delivery from a delivery company to the receiver a few days before an appointed delivery date. For such a system it is required to enter an electronic mail address of the receiver on a delivery slip, in addition to the name, address, telephone number and the like of the receiver.

Using the electronic mail address, the delivery company sends an electronic mail for giving a notice of delivery to a personal computer or a portable telephone of the receiver a few days before delivery. Such a delivery noticing system realizes reliable delivery.

When an electronic mail address is notified to a delivery company, however, there may arise a problem that direct mails are later sent to the receiver or the electronic mail address is used for sales promotion by a third party. Since annoying mails are today's social problem, users tend to refuse to notify delivery companies of their electronic mail addresses especially. Such a situation has hindered the development of the delivery noticing system. Moreover, when a telephone number of a receiver is entered, there arises a problem that private information including the entered telephone number is used by a delivery company, or other companies, to make a telephone call to a home telephone or a portable telephone of the receiver for the purpose of sales promotion or sales inducement.

### BRIEF SUMMARY OF THE INVENTION

The present invention has been made with the aim of solving the above problems.

It is an object of the present invention to provide a delivery noticing method and the like having an apparatus for mediating a delivery noticing process between a delivery company and a service provider which possesses information on communication addresses, with which method a previous notice of delivery can be given to a receiver without notifying the delivery company of the receiver's communication address such as his electronic mail address or his telephone number.

The delivery noticing method according to the present invention, which gives a previous notice of delivery to a receiver, who receives a delivery, through a central apparatus for managing information related to the delivery including information on the receiver and a plurality of server computers of service providers, comprises the steps of storing in advance a receiver in relation to a service provider used by the receiver in service provider database; accepting information related to the delivery by the central apparatus; retrieving the service provider used by the receiver from the service provider database; generating delivery noticing information based on the accepted information related to the delivery; transmitting the generated delivery noticing information with information on the receiver from the central apparatus to a server computer of the retrieved service provider; storing in advance a communication address of the receiver in relation to the receiver in address database which the server computer can access; retrieving the communication address from the address database based on the transmitted information on the receiver; and transmitting the transmitted delivery noticing information from the server computer to the retrieved communication address.

In the invention, a previous notice of delivery can be given without notifying a transport firm or a forwarding agency, such as a delivery company, of a communication address such as an electronic mail address or a telephone number. For this purpose, the system is constructed of server computers of service providers such as providers or carriers possessing information on communication addresses and a central apparatus for executing a process for giving a previous notice of delivery, which is connected to a server computer of each service provider.

Service provider database stores in advance a receiver in relation to a service provider used by the receiver. The central apparatus accepts information related to the delivery sent to the receiver (the name and address of the receiver and contents of the delivery, for example). Next, a service provider used by the receiver is retrieved from the service provider database. Along this, delivery noticing information is generated based on the accepted information related to the delivery. Furthermore, the central apparatus transmits the generated delivery noticing information with information on the receiver to a server computer of the retrieved service provider.

On the other hand, address database, which the server computer of the service provider can access, stores in advance a communication address of the receiver in relation to the receiver. The server computer retrieves the communication address from the address database based on the transmitted information on the receiver. The transmitted delivery noticing information is then transmitted to the retrieved communication address. As a result, there is no need to notify the delivery company of the receiver's communication address, and the receiver can therefore escape damage such as receiving an annoying mail or a call for sales inducement. Moreover, a delivery noticing service using an electronic mail or the like can be performed more smoothly.

The above and further objects and features of the invention will more fully be apparent from the following detailed description with accompanying drawings.

### BRIEF DESCRIPTION OF THE SEVERAL VIEWS OF THE DRAWINGS

FIG. 1 is a schematic view showing the structure of a delivery noticing system according to the present invention;

FIG. 2 is a block diagram showing the hardware structure of a central apparatus;

FIG. 3 is an explanatory view showing the record layout of provider database;

FIG. 4 is an explanatory view showing the record layout of notice database;

FIG. 5 is a block diagram showing the hardware structure of a server computer;

FIG. 6 is an explanatory view showing the record layout of address database;

FIG. 7 is an explanatory view showing the image of delivery noticing information;

FIG. 8 is an explanatory view showing the image of change menu;

FIGS. 9A and 9B are flow charts showing a processing procedure for giving a previous notice of delivery;

FIG. 10 is a schematic view showing the structure of a delivery noticing system according to Second Embodiment;

FIG. 11 is a block diagram showing the hardware structure of a server computer according to Second Embodiment;

FIGS. 12A and 12B are flow charts showing a processing procedure for giving a previous notice of delivery;

FIG. 13 is a block diagram showing the hardware structure of a central apparatus according to Third Embodiment;

FIG. 14 is a block diagram showing the hardware structure of a server computer according to Third Embodiment;

FIG. 15 is a block diagram showing the hardware structure of a server computer according to Third Embodiment;

FIG. 16 is a schematic view for schematically showing a delivery noticing system according to Fourth Embodiment;

FIG. 17 is an explanatory view showing the image of delivery registration menu on an order accepting apparatus;

FIG. 18 is a block diagram showing the hardware structure of a central apparatus according to Fourth Embodiment;

FIG. 19 is an explanatory view showing the record layout of carrier database;

FIG. 20 is an explanatory view showing the record layout of notice database according to Fourth Embodiment;

FIG. 21 is an explanatory view for explaining contents of voice data;

FIG. 22 is a block diagram showing the hardware structure of a server computer according to Fourth Embodiment;

FIG. 23 is an explanatory view showing the record layout of communication address database;

FIGS. 24A and 24B are flow charts showing a processing procedure executed between an order accepting apparatus and a central apparatus; and

FIGS. 25A through 25D are flow charts showing an information processing procedure between a central apparatus, a server computer and an information processor.

### DETAILED DESCRIPTION OF THE INVENTION

### First Embodiment

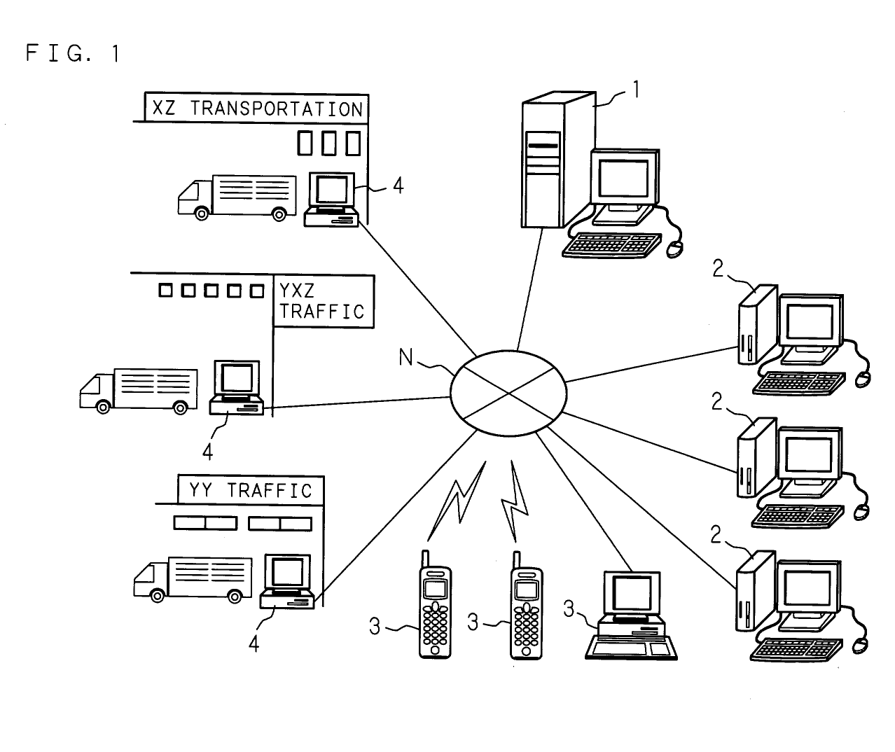

FIG. 1 is a schematic view showing the structure of a delivery noticing system according to the present invention. In this figure, each reference numeral 4 indicates an order accepting apparatus used by a delivery company. The order accepting apparatus 4 accepts information related to a delivery (such as the name and address of the receiver and contents of the delivery). The accepted information related to the delivery is transmitted to a central apparatus 1 which is connected with the order accepting apparatus 4 via a communication network N such as the Internet. It should be noted that the following description uses an electronic mail as an example of a communication address.

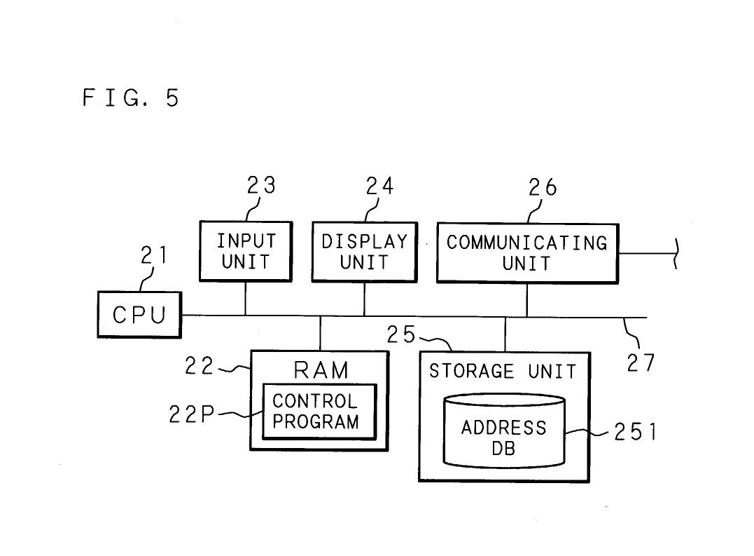

The central apparatus 1 is connected via the communication network N to server computers 2 of service providers such as providers and carriers, and to each information processor 3 such as a portable telephone, a PDA (Personal Digital Assistant) or a personal computer used by a receiver. It should be noted that the following description uses a provider as an example of a service provider. The central apparatus 1 does not possess information on electronic mail addresses of receivers, and only server computers 2 can access service address database (hereinafter referred to as address DB) (see FIG. 5) which stores a receiver in relation to an electronic mail address of the receiver.

When the order accepting apparatus 4 transmits the information related to the delivery, the central apparatus 1 generates delivery noticing information and retrieves a provider used by the receiver. The central apparatus 1 then transmits the information on the receiver and the delivery noticing information to a server computer 2 of the retrieved provider. The server computer 2 of the provider possesses an electronic mail address of the receiver as a matter of course. Consequently, the server computer 2 retrieves an electronic mail address corresponding to the receiver and then transmits the delivery noticing information to the address. Since the delivery noticing information is transmitted to the information processor 3 used by the receiver, a user can use the service without notifying a delivery company of his electronic mail address.

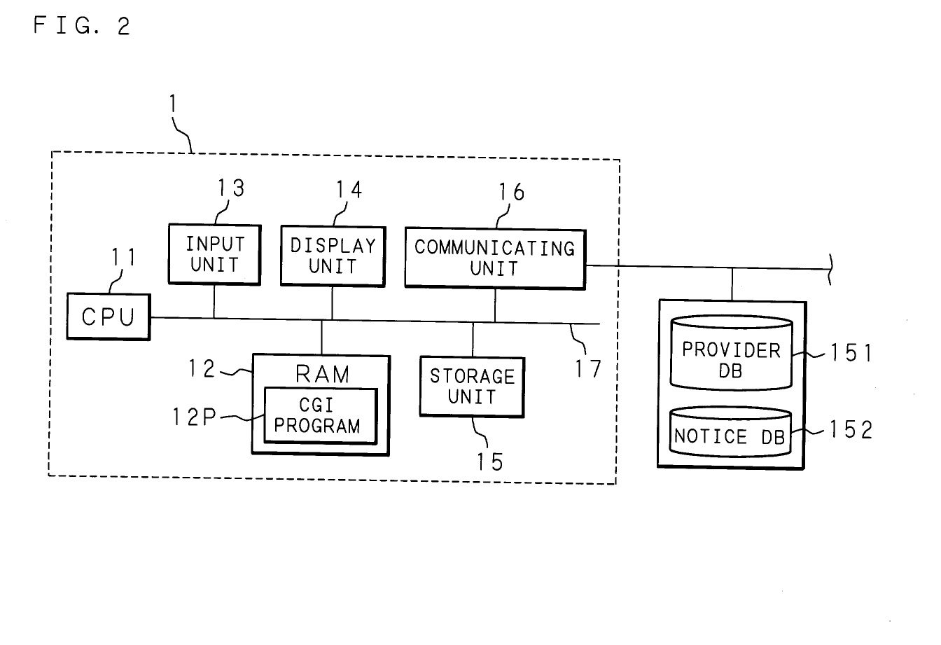

FIG. 2 is a block diagram showing the hardware structure of the central apparatus 1. As shown in this figure, the central apparatus 1 functions as an http (Hypertext Transfer Protocol) server engine connected to the Internet (a communication network N). A CPU (Central Processing Unit) 11 is connected via a bus 17 to a RAM (Random Access Memory) 12, a storage unit 15 such as a hard disk, a communicating unit 16 such as a gateway for transmitting/receiving information to/from the server computer 2 of a provider, the information processor 3 or the order accepting apparatus 4, a display unit 14 such as an LCD (Liquid Crystal Display), and an input unit 13 such as a keyboard and a mouse.

Loaded in the RAM 12 are a CGI (Common Gateway Interface) program 12P and other control programs written in a language such as C or Java (a registered trademark), for executing various processes in response to a demand from the server computer 2, the information processor 3 or the order accepting apparatus 4.

The central apparatus 1 is connected with provider database (hereinafter referred to as provider DB) 151 and notice database (hereinafter referred to as notice DB) 152 which are relational database. The central apparatus 1 as an http server engine writes or retrieves required information by interacting in schema related to a key of a field of each DB with an SQL (Structured Query Language).

As will be described in detail later, the provider DB 151 stores a receiver in relation to a provider used by the receiver. The notice DB 152 stores information related to a delivery, i.e., an invoice number, the name and address of the receiver, a delivery date, contents of the delivery and URL (Uniform Resource Locators) generated for each delivery. It should be noted that the provider DB 151 and the notice DB 152 may be provided in the storage unit 15 of the central apparatus 1.

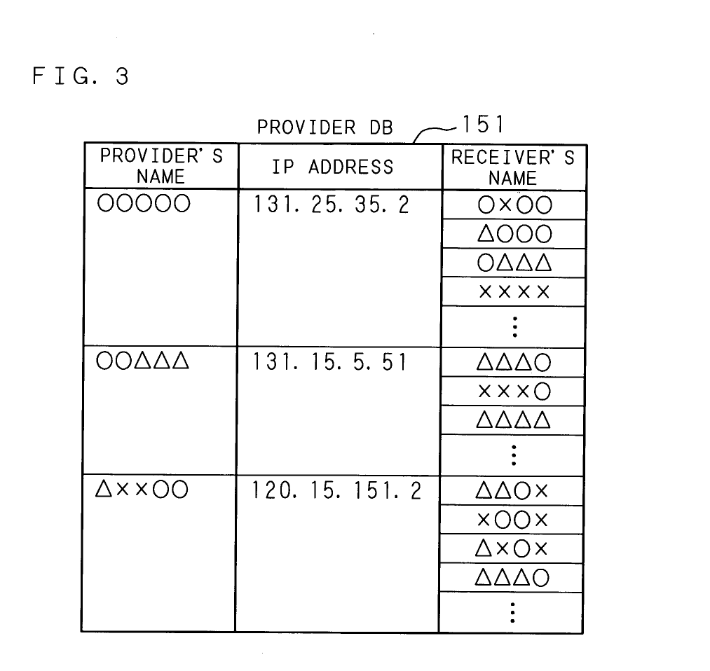

FIG. 3 is an explanatory view showing the record layout of the provider DB 151. As shown in FIG. 3, the provider DB 151 is configured as relational database, and programs written in a language such as the SQL execute various controls for this. An IP (Internet Protocol) address of the server computer 2 of the provider and names of receivers who have contracted with the provider are stored in relation to each provider as shown in the figure.

These information is stored after inputted through the input unit 13 or the like based on the name of the receiver provided by each provider, or transmitted from each provider via the communicating unit 16. It should be noted that information on a provider used by a receiver, which is obtained from a sender, may be inputted as information related to a delivery. When obtaining information related to a delivery from the order accepting apparatus 4, the central apparatus 1 refers to the provider DB 151 and retrieves an IP address of the provider based on the information on the receiver. It also should be noted that, though only names of receivers are stored for each provider in FIG. 3 to simplify the explanation, other information such as addresses may be stored in addition to the names of receivers. In this case, on obtaining information related to a delivery from the order accepting apparatus 4, the central apparatus 1 refers to the provider DB 151 and retrieves an IP address of the provider used by the receiver based on the information on the name of the receiver.

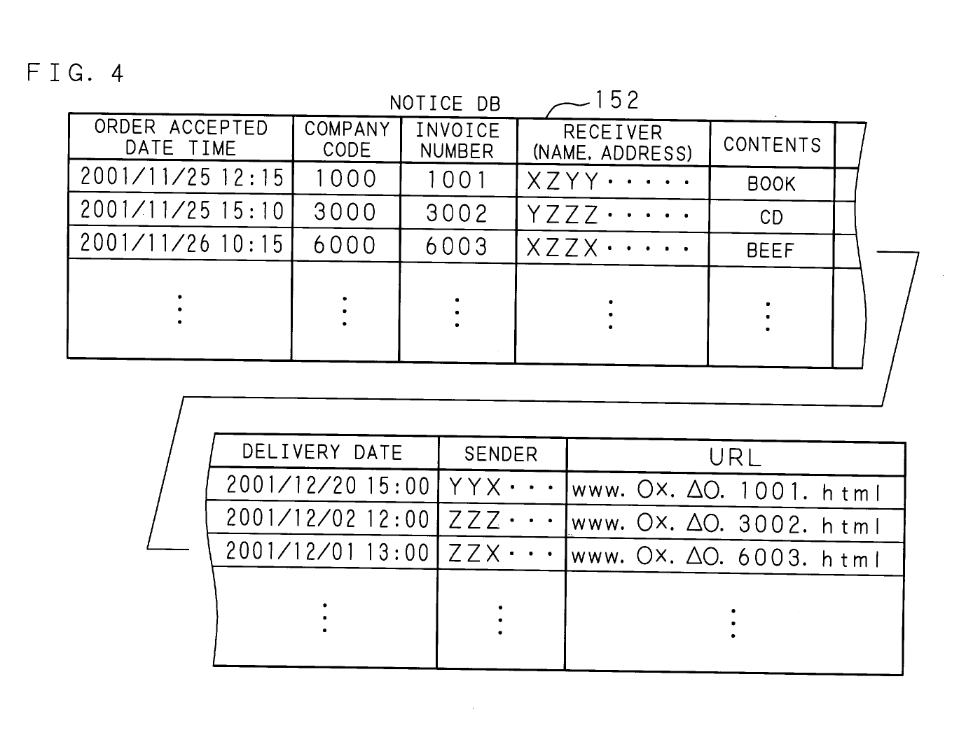

FIG. 4 is an explanatory view showing the record layout of the notice DB 152. As shown in FIG. 4, the notice DB 152 is also configured as relational database, and programs written in a language such as the SQL execute various controls for this. Every time receiving information related to a delivery excluding an electronic mail address from the order accepting apparatus 4, the central apparatus 1 stores an order accepted date time, a company code of the delivery company, an invoice number, information on a receiver (such as the name and address of the receiver), contents of the delivery, appointed delivery date time, information on a sender and the like.

Regarding the invoice No. 1001, for example, it is indicated that a delivery from a sender (YYX) to a receiver (XZYY) was requested from a company identified with a company code 1000 at 12:15 on Nov. 25, 2001. It is also indicated that an appointed delivery date is around 15:00 on Dec. 20, 2001, and the delivery is a “book”. Every time storing such information related to a delivery, the central apparatus 1 generates and stores a unique URL. The URL can be generated as a unique value in accordance with the invoice number. A few days before the delivery date, the central apparatus 1 generates delivery noticing information based on the information related to the delivery including a receiver, contents of the delivery, delivery date time, generated URL and the like, and transmits the delivery noticing information to a provider corresponding to the receiver. It should be noted that, though the information related to the delivery is transmitted from the order accepting apparatus 4 to the central apparatus 1 as electric data in the resent embodiment, the invention is not limited to this, and data accepted by fax, by mail, or on the telephone may be manually inputted to the central apparatus 1.

FIG. 5 is a block diagram showing the hardware structure of the server computer 2. As shown in this figure, a CPU 21 is connected via a bus 27 to a RAM 22, a storage unit 25 such as a hard disk, a communicating unit 26 such as a gateway for transmitting/receiving information to/from the central apparatus 1, the information processor 3 or the like, a display unit 24 such as an LCD, and an input unit 23 such as a keyboard and a mouse. Loaded in the RAM 22 are a control program 22P for controlling the storage unit 25, the display unit 24, the input unit 23 and the like, a browser and the like.

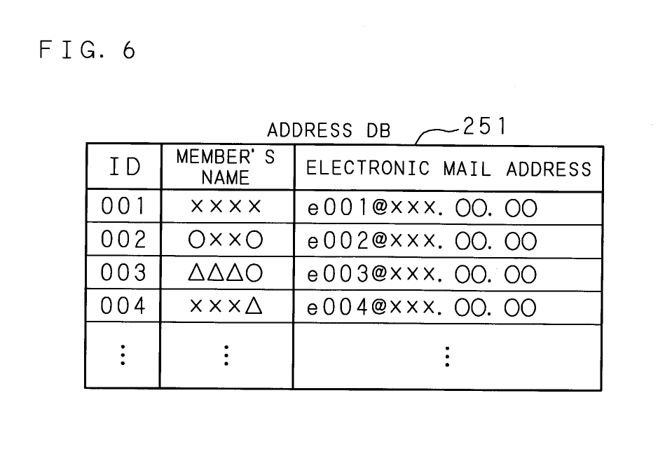

Provided in the storage unit 25 is an address database (hereinafter referred to as an address DB) 251 which stores electronic mail addresses of members who use the service of the provider. FIG. 6 is an explanatory view showing the record layout of the address DB 251. As shown in FIG. 6, the address DB 251 is configured as relational database, and programs written in a language such as the SQL execute various controls for this. As shown in the figure, an electronic mail address of each member is stored in relation to an ID and the name of the member. When delivery noticing information for a receiver is transmitted from the central apparatus 1, the server computer 2 retrieves a field for names of members based on the information on the receiver with the SQL to retrieve a corresponding electronic mail address. The server computer 2 then transmits the received delivery noticing information to the retrieved electronic mail address. It should be noted that, though the name of a member is stored in relation to his electronic mail address in FIG. 6 to simplify the explanation, other information such as the address of the member may be stored in addition to the name of the member. In this case, when the central apparatus 1 transmits delivery noticing information for the receiver, the server computer 2 retrieves the name or address of the member based on the information on the name or address of the receiver with the SQL. The server computer 2 then retrieves a corresponding electronic mail address, and transmits the received delivery noticing information to the retrieved electronic mail address.

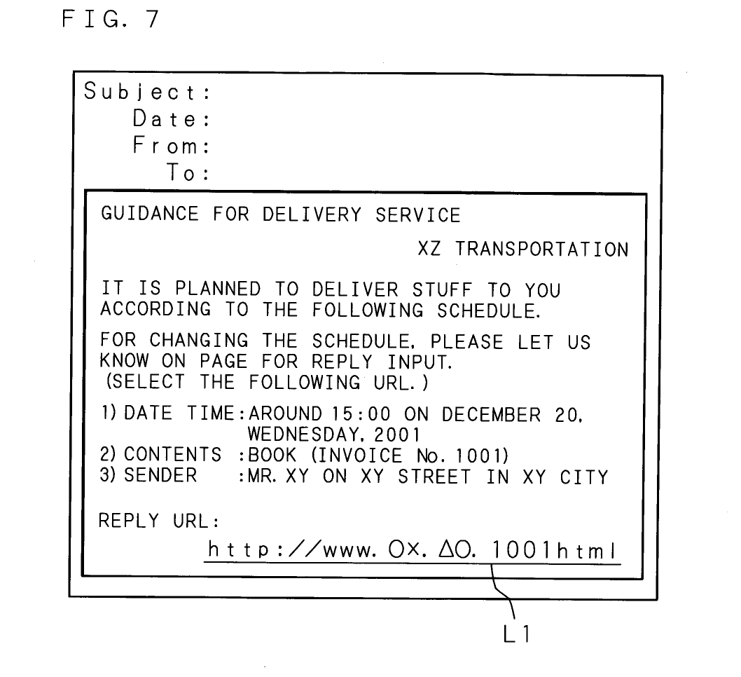

FIG. 7 is an explanatory view showing the image of delivery noticing information. The delivery noticing information is transmitted from the server computer 2 to the information processor 3 in an electronic mail form. The delivery noticing information includes information on a delivery date time, contents of the delivery and the like. The URL generated as the delivery noticing information is also displayed as shown by a hyperlink L1. When a user clicks at the hyperlink L1 for changing the appointed delivery date, the process jumps to a linked URL.

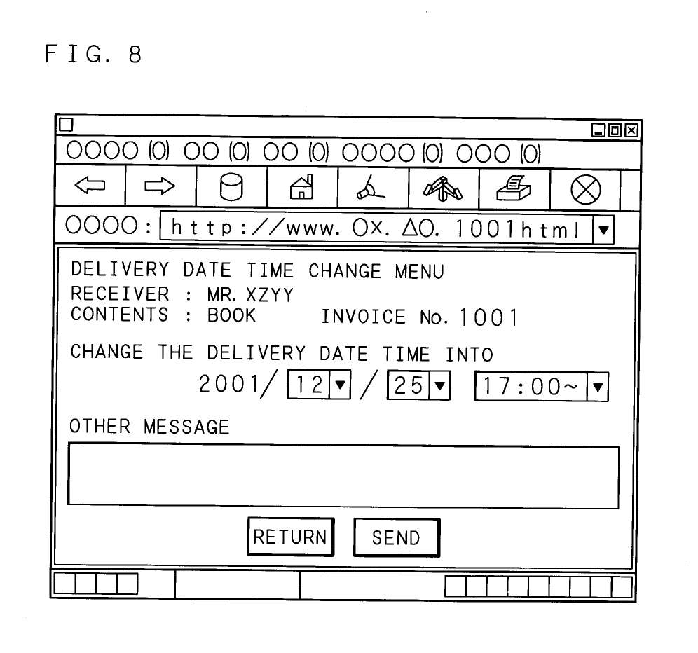

When the central apparatus 1 accepts an access to the URL, the central apparatus 1 generates an SQL in accordance with the transmitted URL, and transforms the information related to a delivery extracted from the notice DB 152, such as an receiver and a delivery date time, into HTML and transmits the information to the information processor 3. FIG. 8 is an explanatory view showing the image of change menu. As shown in this figure, the information processor 3 displays information on a receiver, a delivery, a delivery date time and the like on an activated browser. A pull-down box for a delivery date time is provided using Java script or the like, so that a receiver selects a desirable delivery date on the browser.

Information inputted on the browser is transmitted to the central apparatus 1 by clicking at the sending button, and changed information on a delivery date time or the like is updated in the notice DB 152.

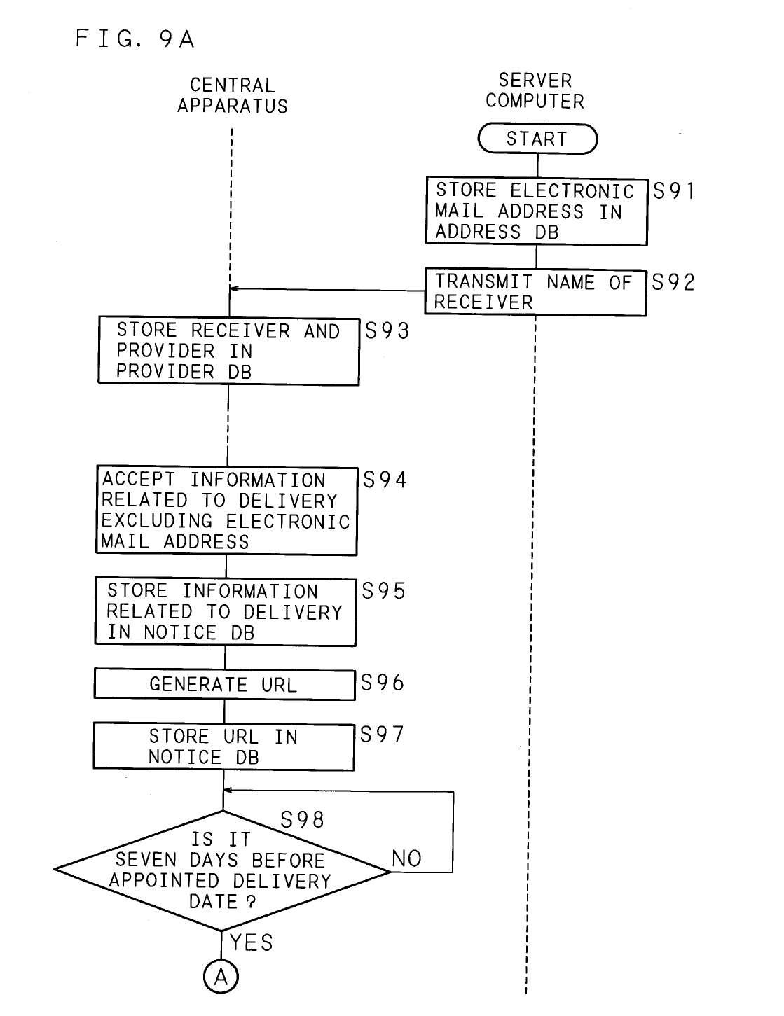

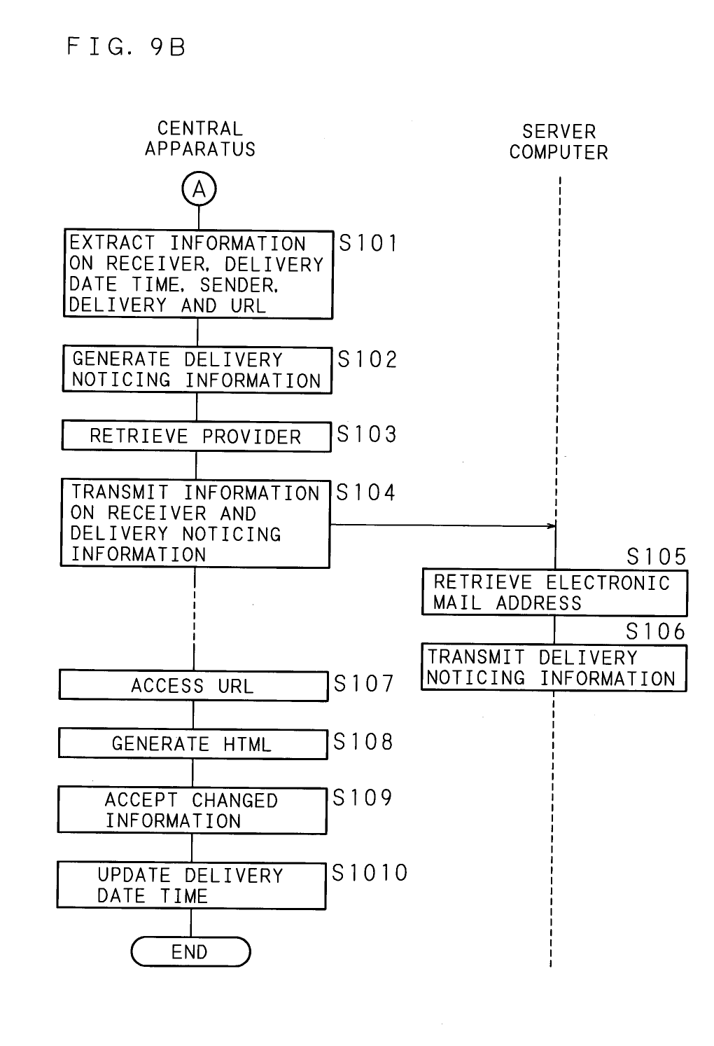

A processing procedure for giving a previous notice of delivery according to the present invention in the above structure is hereinafter explained using flow charts. FIGS. 9A and 9B are flow charts showing a processing procedure for giving a previous notice of delivery. When a user applies for member registration, a provider allocates an electronic mail address to the user. The provider then stores the name and electronic mail address of the member in relation to an ID of the member in the address DB 251 (step S91). The provider invites new members, from the members thereof, who use the delivery noticing service according to the invention as an option. The name of the invited member, i.e. the name of a receiver, is then transmitted to the central apparatus 1 (step S92).

The central apparatus 1 stores the name of the receiver transmitted from each provider in relation to each provider in the provider DB 151 (step S93). This makes it possible to identify one provider uniquely for one receiver.

When a user requests delivery to a delivery company, he enters on the application form information related to a delivery on a sender, a receiver, contents of the delivery, an appointed delivery date time and the like, excluding an electronic mail address. The entered information related to the delivery is inputted into the order accepting apparatus 4 of the delivery company, and transmitted to the central apparatus 1. The central apparatus 1 accepts the information related to the delivery excluding an electronic mail address (step S94). The accepted information related to the delivery is stored in the notice DB 152 (step S95). For storing the information in the notice DB 152, the central apparatus 1 stores an order accepted date time referring to date time data outputted from an unrepresented timing unit. Moreover, an invoice number, a company code and the like which the company has sent are also stored in the notice DB 152 as information related to a delivery.

Every time receiving information related to a delivery, the central apparatus 1 generates a unique URL (step S96). This URL is used by the receiver for changing the appointed delivery date time, and is generated as a unique value based on information on an order accepted date time, an invoice number or the like. The generated URL is stored in the notice DB 152 as information related to the delivery (step S97). As described above, the central apparatus 1 stores information related to a delivery in the notice DB 152 every time receiving the information from each order accepting apparatus 4.

The central apparatus 1 compares date time data outputted from the unrepresented timing unit with an appointed delivery date time, and judges whether the date time data is seven days before the appointed delivery date (step S98). When it is not seven days before the appointed delivery date (NO in the step S98), the process is performed repeatedly until it becomes seven days before the appointed delivery date. On the other hand, when it is seven days before the appointed delivery date (YES in the step S98), information corresponding to the day which is seven days before the delivery date time is extracted from each of the fields for a delivery, a receiver, a delivery date time, a sender and URL in the notice DB 152 (step S101). It should be noted that the value of seven may be changed to any value, for example one, through the input unit 13.

The central apparatus 1 transforms the extracted information to generate delivery noticing information (step S102). In particular, as sown in FIG. 7, the central apparatus 1 reads a template text for a previous notice of delivery from the storage unit 15, and writes information on a delivery, a receiver, a delivery date time, a sender and URL as text data, in order in a predetermined area. The URL used for changing the delivery date time is also generated as delivery noticing information. Though generation of the delivery noticing information is processed by the central apparatus 1 in the present embodiment, the invention is not limited to this. Information related to a delivery may be transmitted to the server computer 2, the notice DB 152 may be provided in the server computer 2, and the delivery noticing information may be generated in the server computer 2.

Next, the central apparatus 1 retrieves a provider corresponding to a receiver from the provider DB 151 based on information on the receiver who should receive the delivery noticing information (step S103). When the retrieval of the provider ends, information on the receiver and the generated delivery noticing information addressed to the IP address of the corresponding provider is transmitted to the server computer 2 (step S104). Based on the transmitted information on the receiver, the server computer 2 retrieves an electronic mail address of the receiver referring to the address DB 251 (step S105). The server computer 2 then transmits the delivery noticing information addressed to the retrieved electronic mail address to the information processor 3 (step S106).

The following description will explain a processing procedure performed when the receiver, who has received the delivery noticing information shown in FIG. 7, changes the appointed delivery date time. By clicking at the hyperlink L1 shown in FIG. 7, the receiver activates a browser and accesses the allocated URL (step S107). The central apparatus 1 generates an SQL corresponding to the URL, extracts information related to a delivery on a receiver, a delivery date time and the like, and generates an HTML (step S108). The generated HTML is transmitted to the information processor 3 of the receiver, and displayed on a browser as shown in FIG. 8.

The receiver selects a desirable delivery date time from the pull-down box on the browser, and the changed information is transmitted to the central apparatus 1 again. The central apparatus 1 accepts the changed information which has been transmitted (step S109) and updates information on a delivery date time registered in the notice DB 152 using the invoice number or the like included in the changed information as a key (step S1010). This allows the receiver to easily change the delivery date time to a desirable one.

### Second Embodiment

Explained in First Embodiment is a system comprising a central apparatus 1 for mediating a delivery noticing process for a plurality of server computers 2 of providers. However, the invention is not limited to this, and a system may be such constructed that a server computer 2 has a function of the above central apparatus 1. Such a case will be described in detail hereinafter.

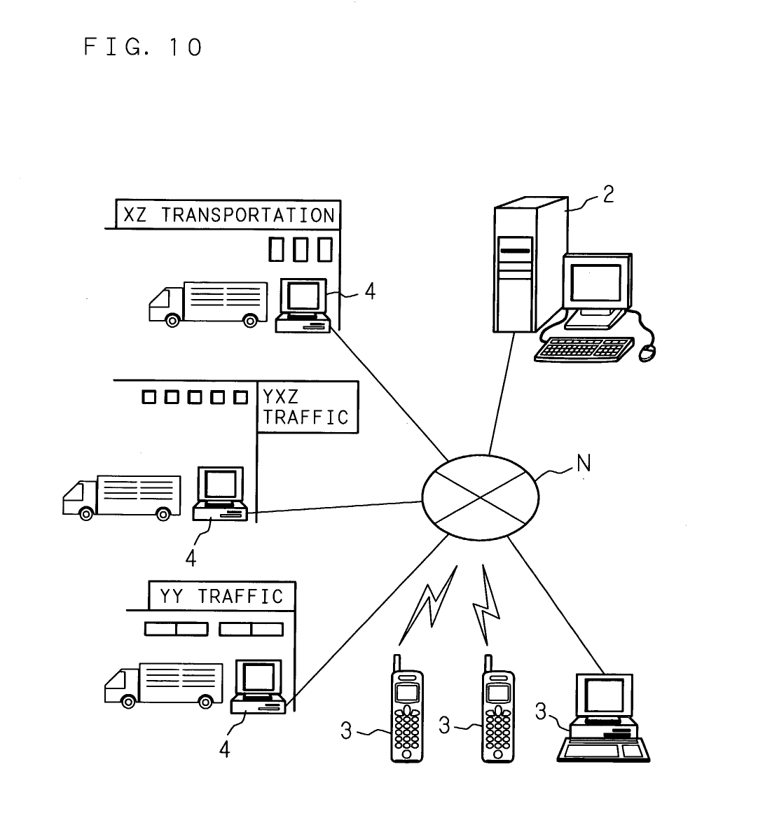

FIG. 10 is a schematic view showing the structure of a delivery noticing system according to Second Embodiment. In this figure, each reference numeral 4 indicates an order accepting apparatus used by a delivery company. The order accepting apparatus 4 accepts information related to a delivery (information on the name and address of the receiver, and contents of the delivery) excluding an electronic mail address. The accepted information related to the delivery is transmitted to a server computer 2 of a provider connected with the order accepting apparatus 4 via a communication network N such as the Internet. As described above, this embodiment uses only the server computer 2 of the provider, and not the central apparatus 1.

The server computer 2 is connected via the communication network N to each information processor 3 such as a portable telephone, a PDA or a personal computer used by a receiver. When the order accepting apparatus 4 transmits information related to a delivery, the server computer 2 generates delivery noticing information and retrieves an electronic mail address based on the information on the receiver. The server computer 2 then transmits the delivery noticing information to the retrieved electronic mail address.

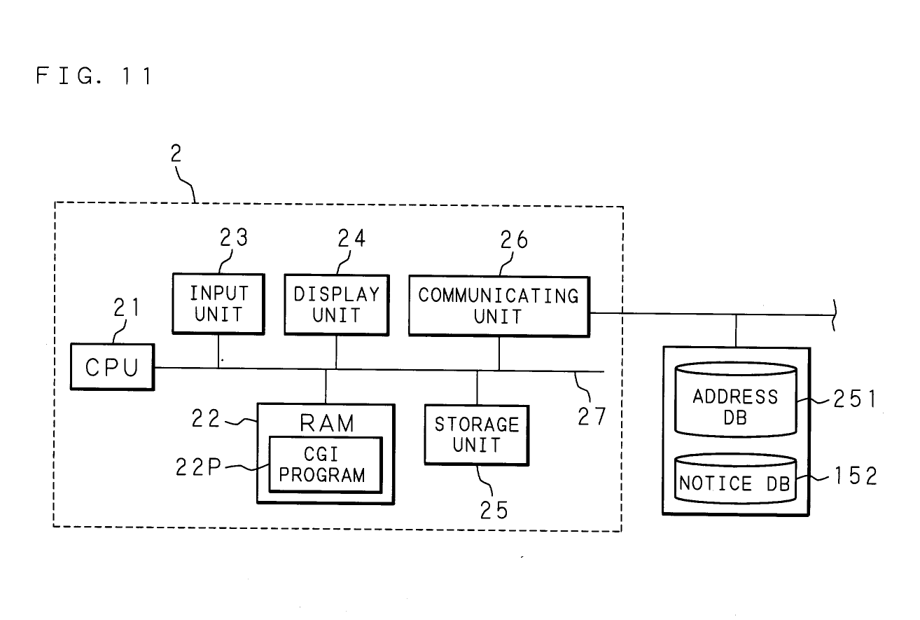

FIG. 11 is a block diagram showing the hardware structure of a server computer 2 according to Second Embodiment. As shown in this figure, the server computer 2 functions as an http server engine connected to the Internet (a communication network N). A CPU 21 is connected via a bus 27 to a RAM 22, a storage unit 25 such as a hard disk, a communicating unit 26 such as a gateway for transmitting/receiving information to/from an information processor 3 or an order accepting apparatus 4, a display unit 24 such as an LCD, and an input unit 23 such as a keyboard and a mouse.

Loaded in the RAM 22 are a CGI program 22P and other control programs written in a language such as C or Java, for executing various processes in response to a demand from the information processor 3 or the order accepting apparatus 4.

The server computer 2 is connected with address DB 251 and notice DB 152 which are relational database. The server computer 2 as an http server engine writes or retrieves required information by interacting in each schema related to a key of a field of each DB with an SQL. The contents of each DB are explained in First Embodiment, and detailed description thereof is omitted here.

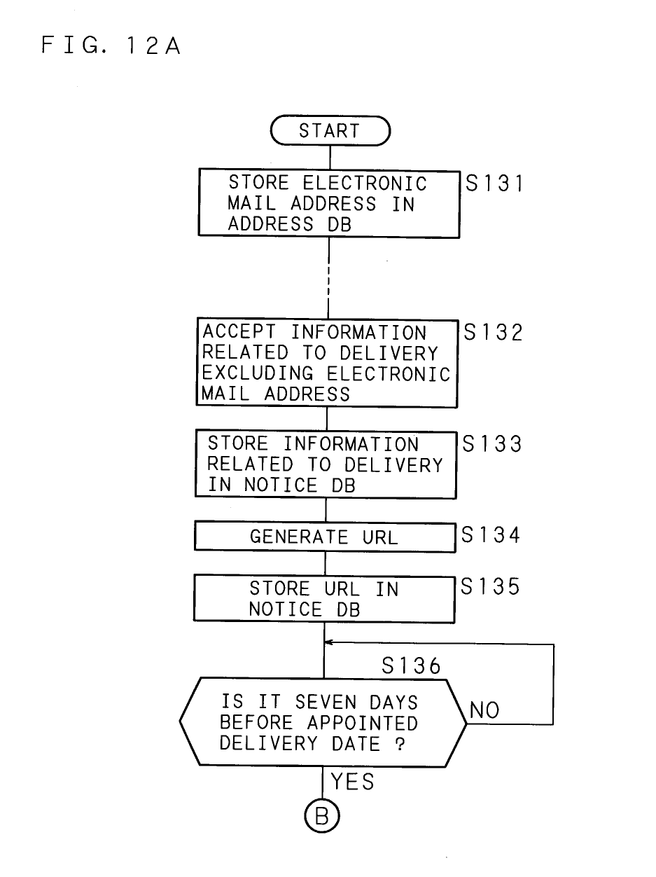

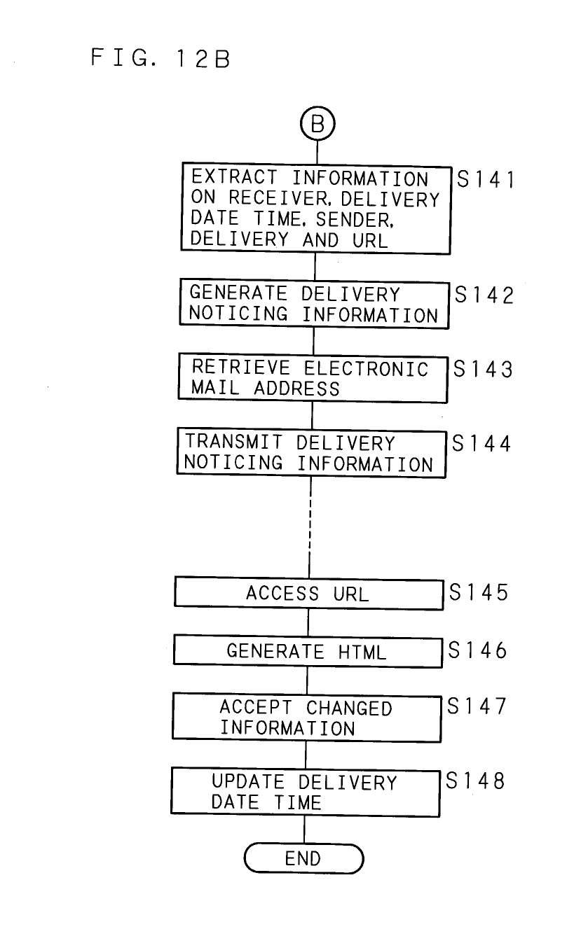

A processing procedure for giving a previous notice of delivery according to Second Embodiment in the above structure is hereinafter explained using flow charts. FIGS. 12A and 12B are flow charts showing a processing procedure for giving a previous notice of delivery. When a user applies for member registration, a provider allocates an electronic mail address to the user and stores in the address DB 251 the name and electronic mail address of the member in relation to his ID (step S131).

When a user requests delivery to a delivery company, he enters on the application form information related to a delivery on a sender, a receiver, contents of the delivery, an appointed delivery date time and the like, excluding an electronic mail address. The entered information related to the delivery is inputted into the order accepting apparatus 4 of the delivery company, and transmitted to the server computer 2. The server computer 2 accepts the transmitted information related to the delivery excluding an electronic mail address (step S132). The accepted information related to the delivery is stored in the notice DB 152 (step S133). In storing the information in the notice DB 152, the server computer 2 refers to date time data outputted from an unrepresented timing unit and stores an order accepted date time. Moreover, an invoice number, a company code and the like which the company has sent are also stored in the notice DB 152 as information related to the delivery.

Every time receiving information related to the delivery, the server computer 2 generates a unique URL (step S134). This URL is used by the receiver for changing the appointed delivery date time, and is generated as a unique value based on information on an order accepted date time, an invoice number or the like. The generated URL is stored in the notice DB 152 as information related to the delivery (step S135). As described above, the server computer 2 stores information related to a delivery in the notice DB 152 every time accepting the information from each order accepting apparatus 4.

The server computer 2 compares date time data outputted from the unrepresented timing unit with an appointed delivery date time, and judges whether the date time data is seven days before the appointed delivery date (step S136). When it is not seven days before the appointed delivery date (NO in the step S136), the process is performed repeatedly until it becomes seven days before the appointed delivery date. On the other hand, when it is seven days before the appointed delivery date (YES in the step S136), information corresponding to the day which is seven days before the delivery date time is extracted from each of the fields for a delivery, a receiver, a delivery date time, a sender and URL in the notice DB 152 (step S141). It should be noted that the value of seven may be changed to any value, for example one, through the input unit 23.

The server computer 2 transforms the extracted information to generate delivery noticing information (step S142). In particular, as sown in FIG. 7, the server computer 2 reads a template text for previous notice of a delivery from the storage unit 25, and writes information on a delivery, a receiver, a delivery date time, a sender and URL as text data, in order in a predetermined area. URL used for changing the delivery date time is also generated as delivery noticing information.

Next, based on the information on the receiver, the server computer 2 retrieves an electronic mail address of the receiver referring to the address DB 251 (step S143). The server computer 2 then transmits the delivery noticing information addressed to the retrieved electronic mail address to the information processor 3 (step S144).

The following description will explain a processing procedure performed when the receiver, who has received the delivery noticing information shown in FIG. 7, changes the appointed delivery date time. By clicking at the hyperlink L1 in the FIG. 7, the receiver activates a browser and accesses the allocated URL (step S145). The server computer 2 generates an SQL in accordance with the URL, extracts information related to the delivery on a receiver, a delivery date time and the like from the notice DB 152, and generates an HTML (step S146). The generated HTML is transmitted to the information processor 3 of the receiver, and displayed on the browser as shown in FIG. 8.

The receiver selects a desirable delivery date time from the pull-down box on the browser, and the changed information is transmitted to the server computer 2 again. The server computer 2 accepts the changed information which has been transmitted (step S147), and updates information on a delivery date time registered in the notice DB 152 (step S148).

Since this Second Embodiment is constructed as above and other structures and functions are the same as those of First Embodiment, like reference numerals are used to refer to like parts and detailed explanation thereof are omitted here.

### Third Embodiment

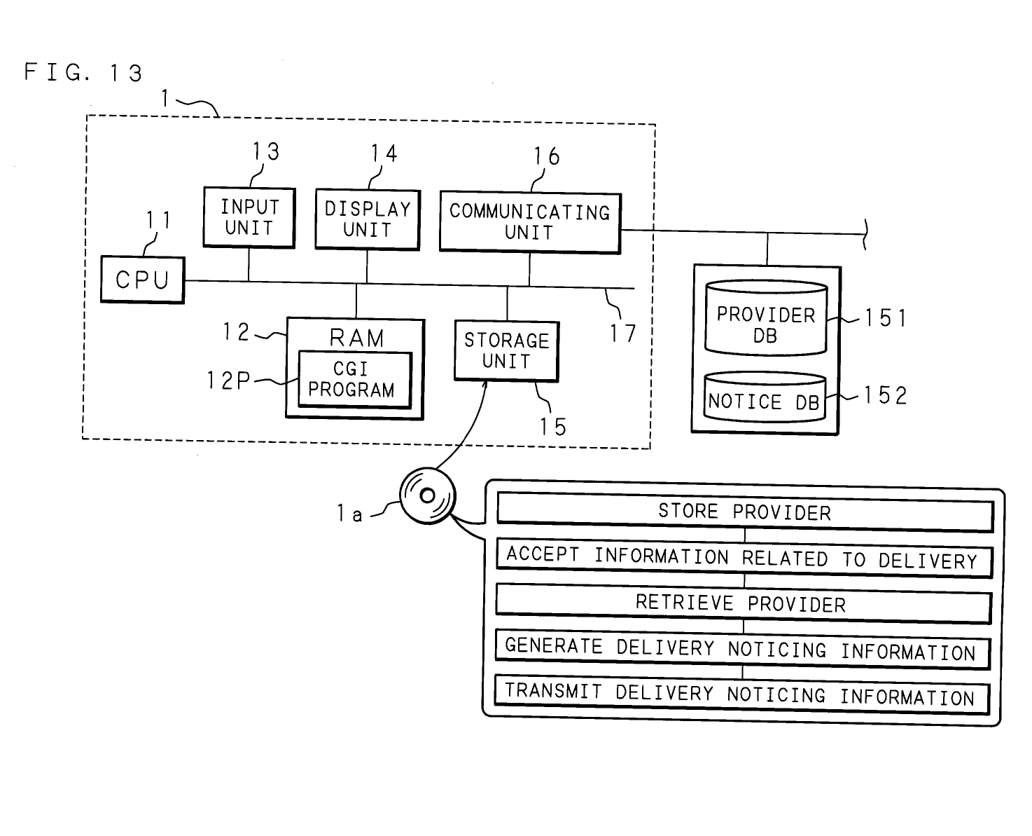

FIG. 13 is a block diagram showing the hardware structure of a central apparatus 1 according to Third Embodiment. Computer programs for executing the central apparatus 1 according to First Embodiment can be provided by pre-installing the programs in the central apparatus 1 as described in this Third Embodiment, or using a portable recording medium such as a CD-ROM or an MO. Moreover, the computer programs can be provided by propagating the programs as carrier wave via lines. The following description will explain this in detail.

Installed in the storage unit 15 of the central apparatus 1 is a recording medium la (such as a CD-ROM, an MO or a DVD-ROM) storing programs which allow the central apparatus 1 shown in FIG. 13 to store providers, accept information related to a delivery, retrieve a provider, generate delivery noticing information and transmit the delivery noticing information. Such programs are executed after loaded in the RAM 12 of the central apparatus 1. This allows the central apparatus 1 of the present invention to function as described above.

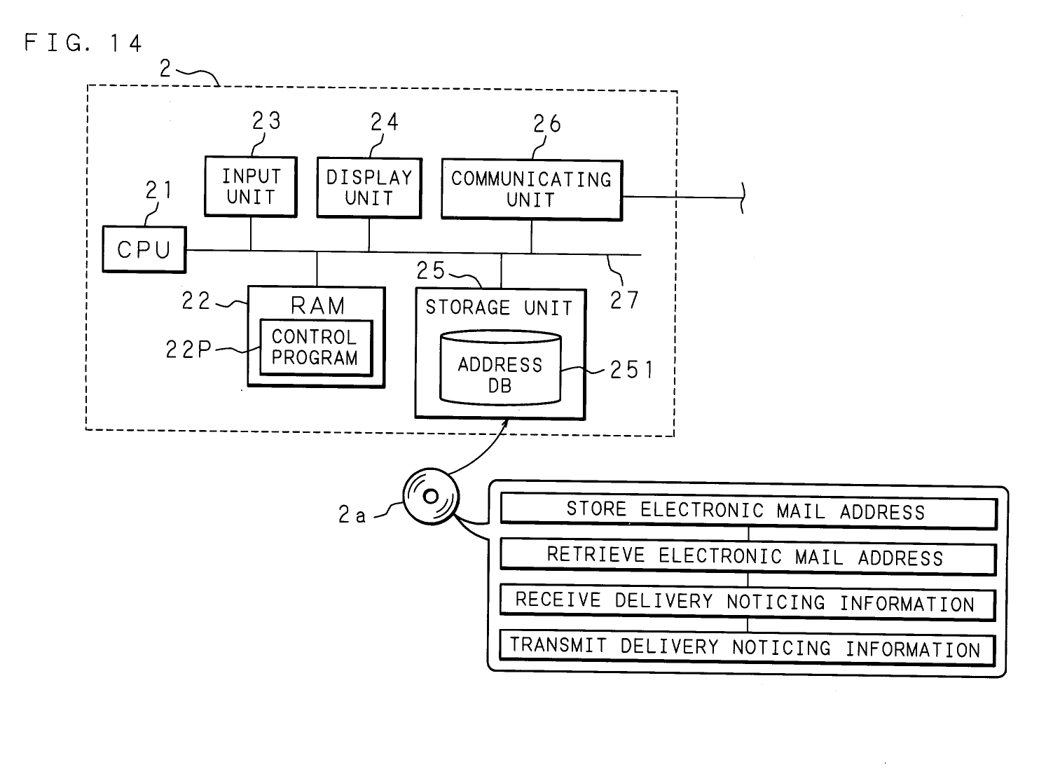

FIG. 14 is a block diagram showing the hardware structure of a server computer 2 of Third Embodiment. Computer programs for executing the server computer 2 according to First Embodiment can be provided by pre-installing the programs in the server computer 2 as described in this Third Embodiment, or using a portable recording medium such as a CD-ROM or an MO. Moreover, the computer programs can be provided by propagating the programs as carrier wave via lines. The following description will explain this in detail.

Installed in the storage unit 25 of the server computer 2 is a recording medium 2a (such as a CD-ROM, an MO or a DVD-ROM) storing programs which allow the server computer 2 shown in FIG. 14 to store electronic mail addresses, retrieve an electronic mail address, receive delivery noticing information and transmit the delivery noticing information. Such programs are executed after loaded in the RAM 22 of the server computer 2. This allows the server computer 2 of the present invention to function as described above.

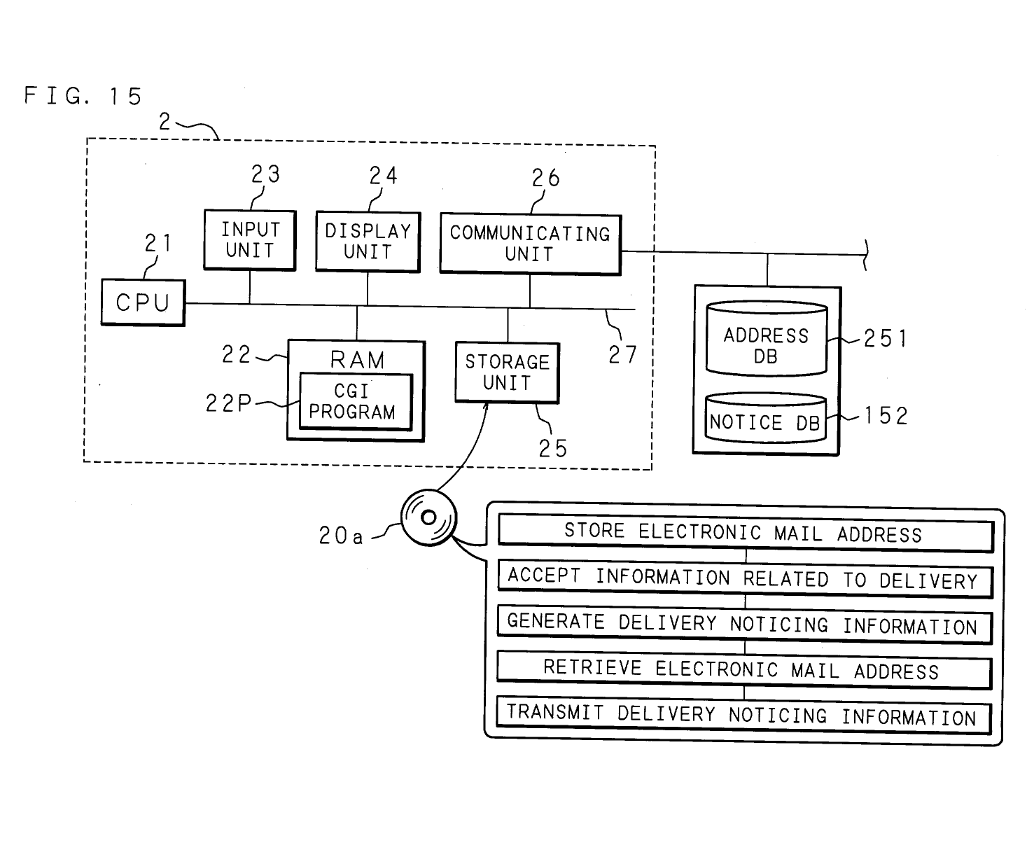

FIG. 15 is a block diagram showing the hardware structure of a server computer 2 according to Third Embodiment. Computer programs for executing the server computer 2 according to Second Embodiment can be provided by pre-installing the programs in the server computer 2 as described in this Third Embodiment, or using a portable recording medium such as a CD-ROM or an MO. Moreover, the computer programs can be provided by propagating the programs as carrier wave via lines. The following description will explain this in detail.

Installed in the storage unit 25 of the server computer 2 is a recording medium 20a (such as a CD-ROM, an MO or a DVD-ROM) storing programs which allow the server computer 2 shown in FIG. 15 to store electronic mail addresses, accept information related to a delivery, generate delivery noticing information, retrieve an electronic mail address and transmit the delivery noticing information. Such programs are executed after loaded in the RAM 22 of the server computer 2. This allows the server computer 2 of the present invention to function as described above.

Since this Third Embodiment is constructed as above and other structures and functions are the same as those of First Embodiment and Second Embodiment, like reference numerals are used to refer to like parts and detailed explanation thereof are omitted here.

### Fourth Embodiment

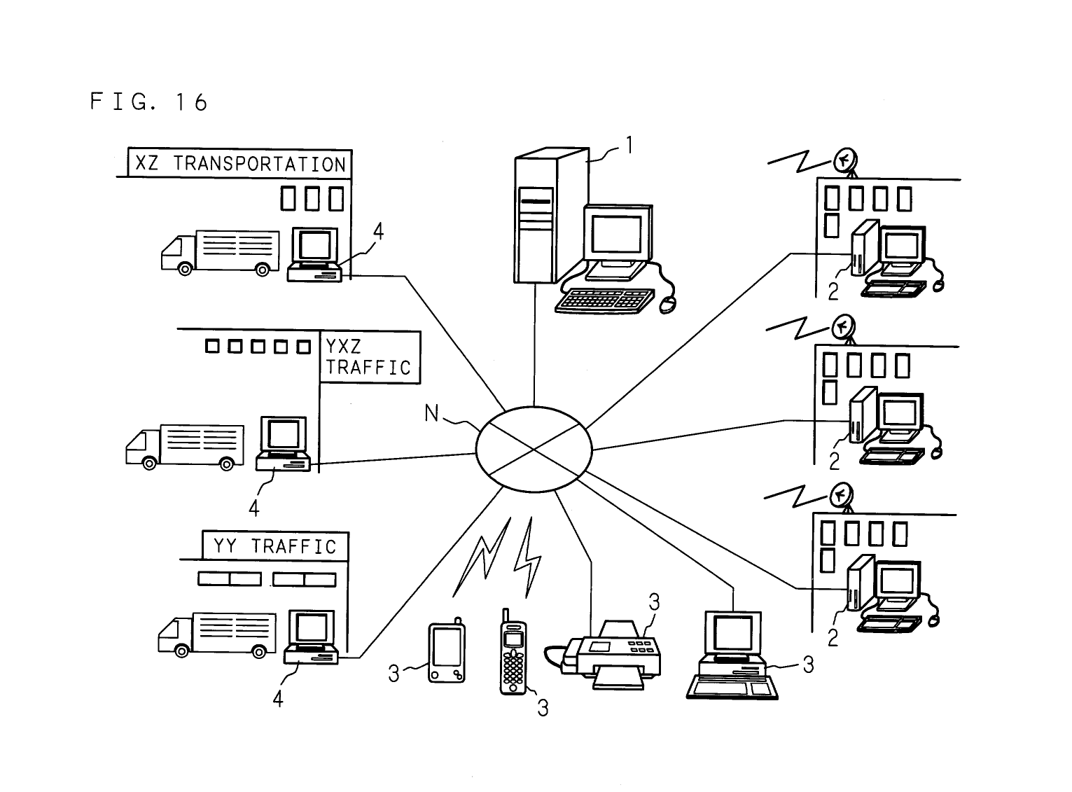

First Embodiment through Third Embodiment use an electronic mail as means for giving a previous notice of delivery. However, other communication means such as a telephone may be used for giving a notice. This will be described in detail in the following. FIG. 16 is a schematic view for schematically showing a delivery noticing system according to Fourth Embodiment. In this figure, each reference numeral 4 indicates an order accepting apparatus used by a delivery company. The order accepting apparatus 4 accepts information related to a delivery (information on the name and address of the receiver, and contents of the delivery). The accepted information related to the delivery is transmitted to a central apparatus 1 connected with the order accepting apparatus 4 via a communication network N such as the Internet.

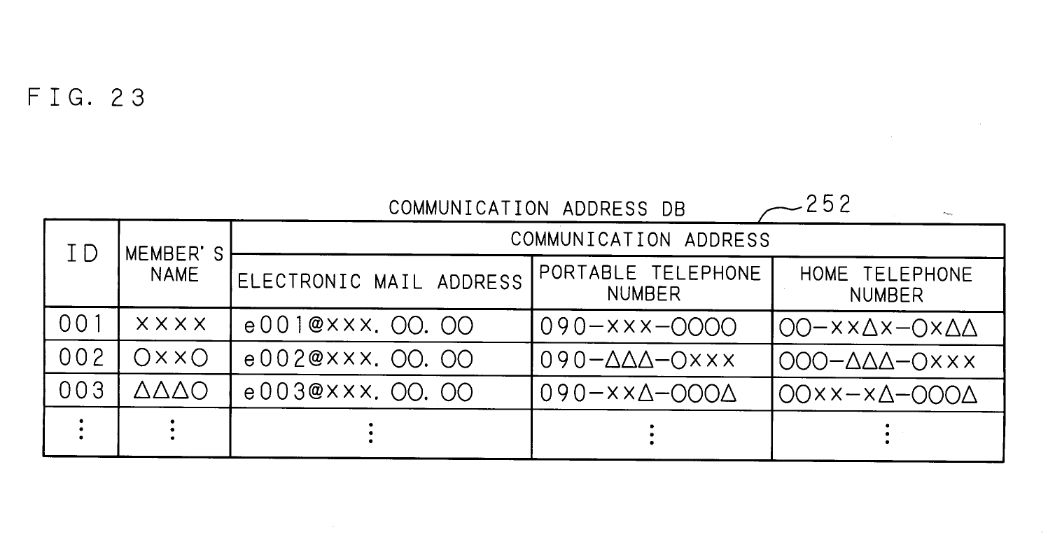

The central apparatus 1 is further connected via the communication network N to server computers 2 of service providers such as a provider and a carrier, and to information processors 3 such as a portable telephone, a PDA, a pager, a fixed telephone and a personal computer used by receivers. It should be noted that the following description uses a carrier as an example of the service provider. The central apparatus 1 does not possess information on a communication address of a receiver, and only server computers 2 can access communication address database (hereinafter referred to as communication address DB) (see FIG. 23) which stores a receiver in relation to a communication address of the receiver.

When the order accepting apparatus 4 transmits the information related to the delivery, the central apparatus 1 generates delivery noticing information and retrieves a carrier used by a receiver. The central apparatus 1 then transmits the information on the receiver and the delivery noticing information to a server computer 2 of the retrieved carrier. The server computer 2 of the carrier possesses a communication address of the receiver such as his electronic mail address, the number of his portable telephone and the number of his fixed telephone (hereinafter referred to as home telephone), as a matter of course. Consequently, the server computer 2 retrieves a communication address corresponding to the receiver, and then sends the delivery noticing information to the communication address by electronic mail or with voice guidance. Since the delivery noticing information is transmitted to the information processor 3 used by the receiver by electronic mail or as voice data, a user can use the service without notifying a delivery company of his communication address.

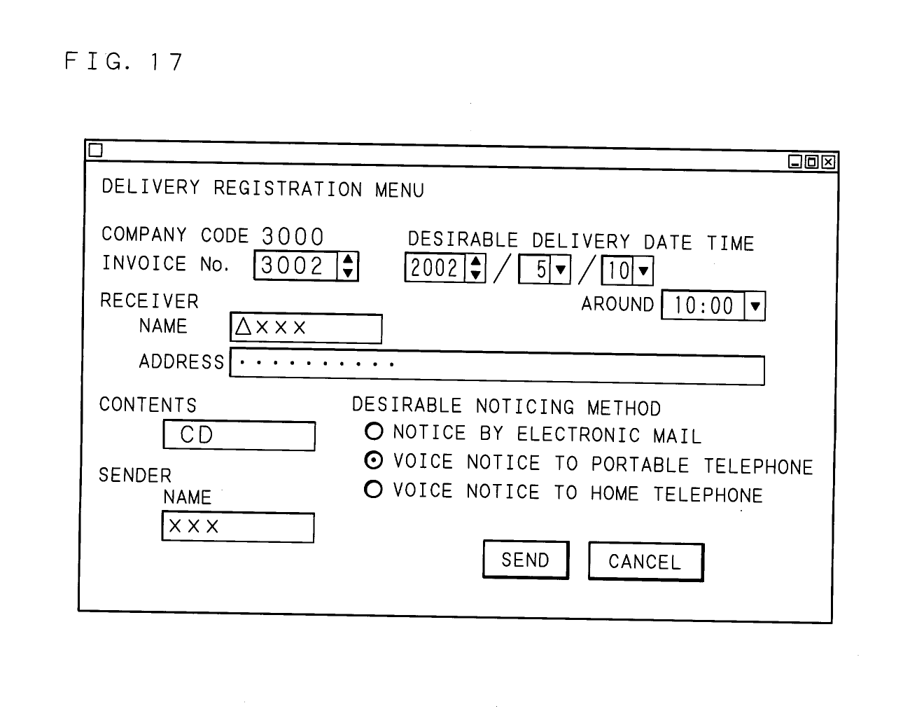

FIG. 17 is an explanatory view showing the image of delivery registration menu on the order accepting apparatus 4. When delivery is requested, a display unit (unrepresented) of the order accepting apparatus 4 displays delivery registration menu, and an operator inputs information related to the delivery through an input unit (unrepresented). In particular, inputted are an invoice number, the name and address of the receiver, contents of the delivery, the name of the sender, a desirable delivery date time and the like. Moreover, for realizing a notice with a portable telephone or a home telephone in addition to a notice by electronic mail, the present embodiment is such constructed that a desirable noticing method can be selected on the delivery registration menu. For designating a method for delivery, a sender selects one from “a notice by electronic mail”, “a voice notice to a portable telephone” and “a voice notice to a home telephone”. It should be noted that the information handled by delivery companies includes no information on the telephone number and the electronic mail address of the receiver. The information related to the delivery which has been inputted as described above is transmitted to the central apparatus 1 by clicking at the sending button.

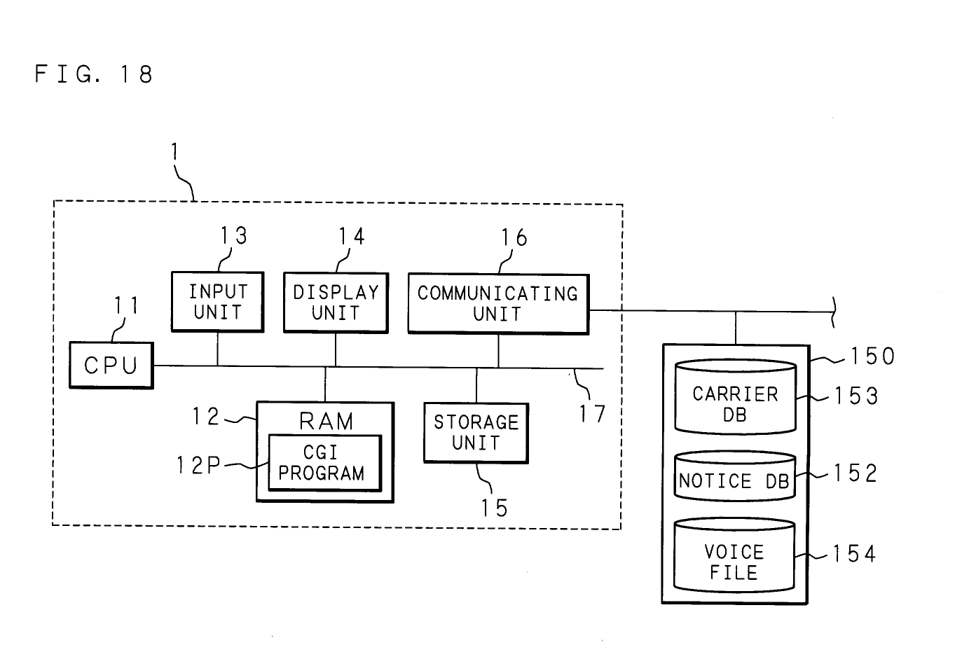

FIG. 18 is a block diagram showing the hardware structure of the central apparatus 1 according to Fourth Embodiment. As shown in this figure, the central apparatus 1 functions as an http server engine connected to the Internet (a communication network N). A CPU 11 is connected via a bus 17 to a RAM 12, a storage unit 15, a communicating unit 16 such as a gateway for transmitting/receiving information to/from a server computer 2 of a carrier, the information processor 3 or the order accepting apparatus 4, a display unit 14, and an input unit 13.

Loaded in the RAM 12 are a CGI program 12P and other control programs written in a language such as C or Java, for executing various processes in response to a demand from the server computer 2, the information processor 3 or the order accepting apparatus 4.

The central apparatus 1 is connected with database server (hereinafter referred to as DB server) 150. The central apparatus 1 as an http server engine writes or retrieves required information by interacting, with an SQL, in each schema related to a key of a field of each DB of carrier database (hereinafter referred to as carrier DB) 153 and notice database (hereinafter referred to as notice DB) 152 in the DB server.

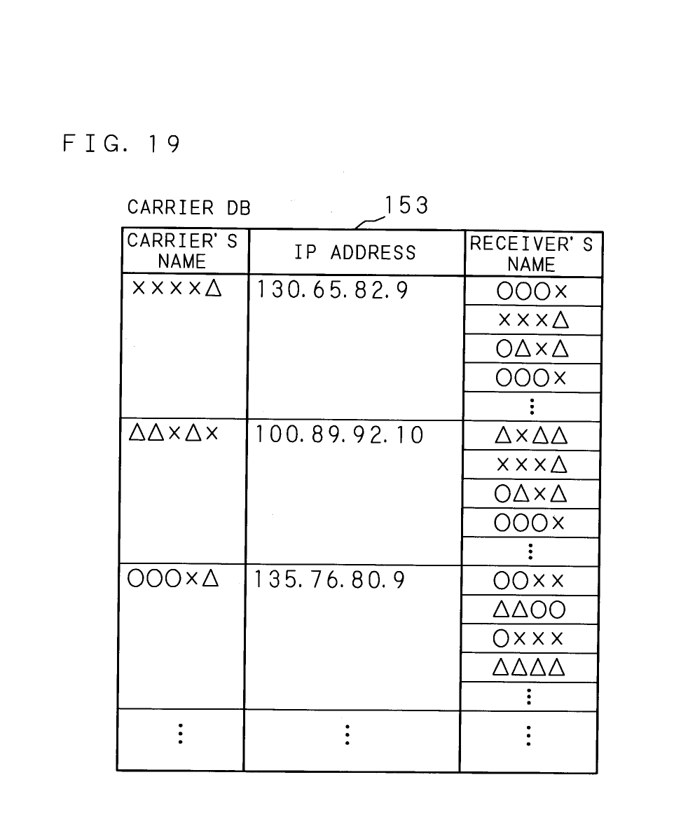

The following description will explain contents of each DB. FIG. 19 is an explanatory view showing the record layout of the carrier DB. The carrier DB 153 stores an IP address of a server computer 2 of the carrier and the name of a customer, i.e. a receiver of the present invention who uses the carrier, in relation to the name of each carrier. Based on the information on the name of the receiver included in the information related to the delivery, the central apparatus 1 retrieves a corresponding carrier and an IP address from the carrier DB 153.

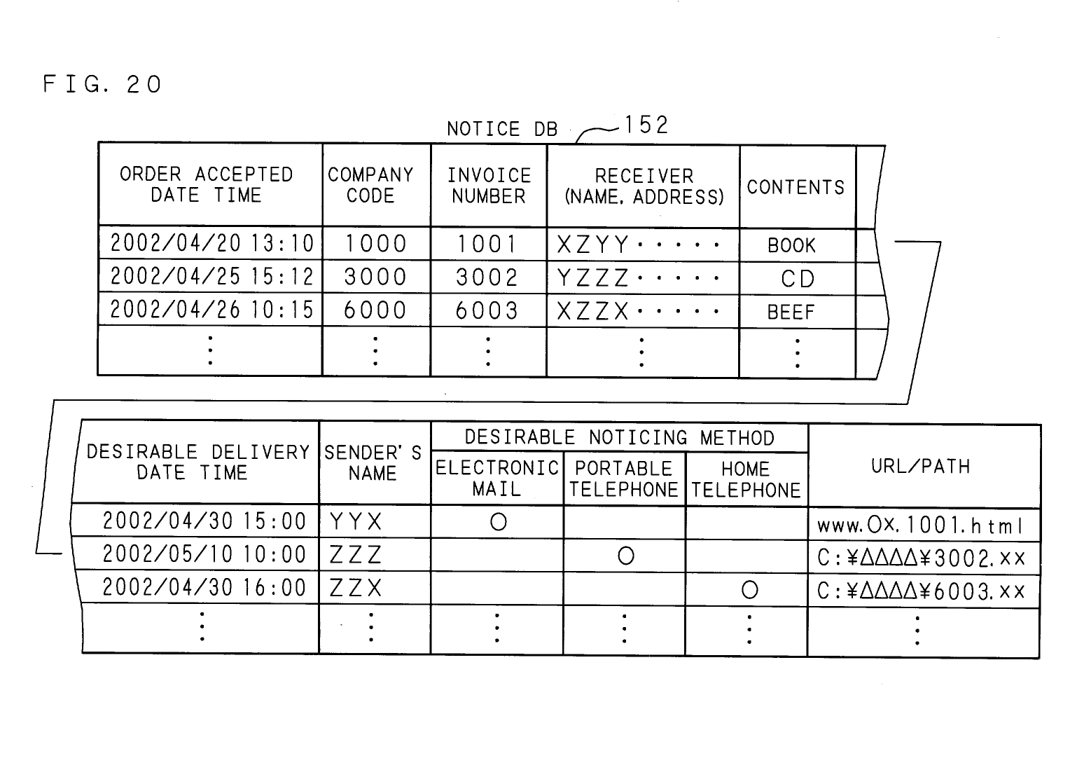

FIG. 20 is an explanatory view showing the record layout of notice DB 152 of Fourth Embodiment. As shown in FIG. 20, the notice DB 152 is also configured as relational database, and programs written in a language such as the SQL execute various controls for this. Every time receiving information related to a delivery excluding a communication address from the order accepting apparatus 4, the central apparatus 1 stores an order accepted date time, a company code of the delivery company, an invoice number, information on a receiver (such as the name and address of the receiver), contents of the delivery, a desirable delivery date time, information on a sender, and a desirable kind of noticing method.

Regarding the invoice No. 1001, for example, it is indicated that a delivery from a sender (YYX) to a receiver (XZYY) was requested from a company identified with a company code 1000 at 13:10 on Apr. 20, 2002. It is also indicated that an appointed delivery date is around 15:00 on Apr. 30, 2002, and the delivery is a “book”. Moreover, the desirable noticing method selected at the order accepting apparatus 4 is also stored.

When the desirable noticing method is an electronic mail, the central apparatus 1 generates and stores a unique URL every time storing these information related to the delivery. URL can be generated as a unique value in accordance with the invoice number. A few days before the delivery date, the central apparatus 1 generates delivery noticing information based on the information related to the delivery including a receiver, contents of the delivery, delivery date time, desirable kind of noticing method, generated URL and the like, and transmits the delivery noticing information to a server computer 2 of a carrier used by the receiver. The process for giving a previous notice of delivery by electronic mail has been explained in First Embodiment, and detailed description thereof is omitted here.

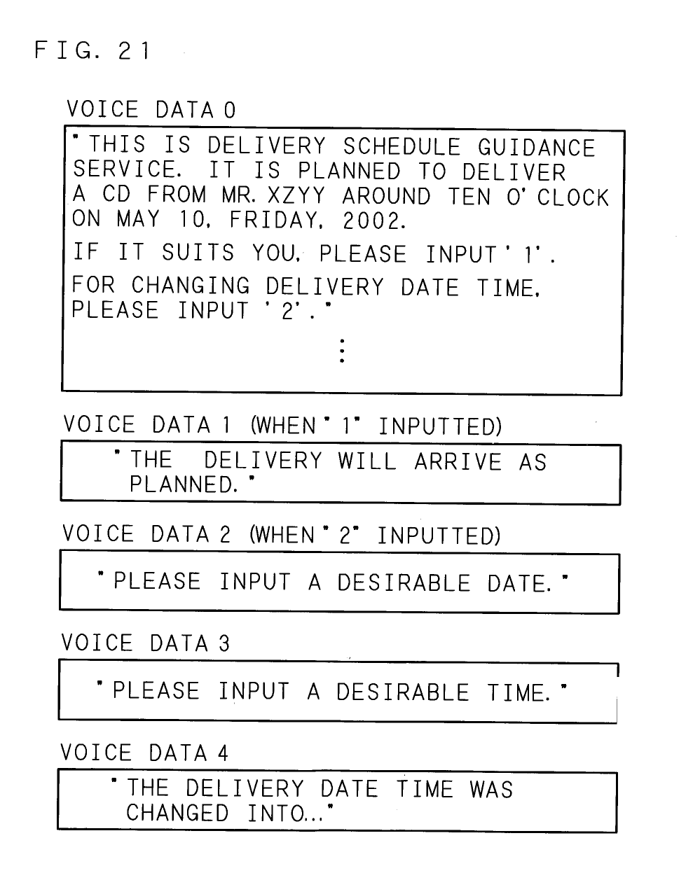

When the desirable noticing method is a notice to a portable telephone or a home telephone, voice data for a notice is stored in a voice file 154 by giving a unique path, every time storing these information related to the delivery. The path can be generated as a unique value in accordance with the invoice number like the URL. FIG. 21 is an explanatory view for explaining contents of voice data. A reference template is prepared in advance for the voice data which is to be stored in the voice file 154, and the information on the name of the sender, the desirable delivery date and the like which has been read from the notice DB 152 is added to the template.

Regarding the invoice No. 3002, for example, the information on the desirable delivery date time and the like which has been suitably read from the notice DB 152 is transformed to a data form of a voice saying, “This is delivery schedule guidance service. It is planned to deliver a CD from Mr. XZYY around ten o'clock on Friday, May 10, 2002. If it suits you, please input ‘1’. For changing the delivery date time, please input ‘2’.” Then this is added to the voice data on the template and stored in a voice file identified with a predetermined path. Hereinafter this voice data is referred to as voice data 0. For a case where the delivery date time is not changed, i.e. for a case where a signal indicating a dial “1” is transmitted, stored is voice data such as “The delivery will arrive as planned.” Hereinafter this voice data is referred to as voice data 1. For a case where the delivery data time is changed, i.e. for a case where a signal indicating a dial “2” is transmitted, stored is voice data such as “Please input a desirable date.” Hereinafter this voice data is referred to as voice data 2. Moreover, voice data saying “Please input a desirable time.” is stored. Hereinafter this voice data is referred to as voice data 3. Furthermore, for a case where a changed delivery date time is inputted, stored is voice data saying, “The delivery date time was changed into . . . ”. Hereinafter this voice data is referred to as voice data 4. These voice data 0 through 4 is transmitted to a server computer 2 of a carrier used by a receiver, as delivery noticing information for the receiver.

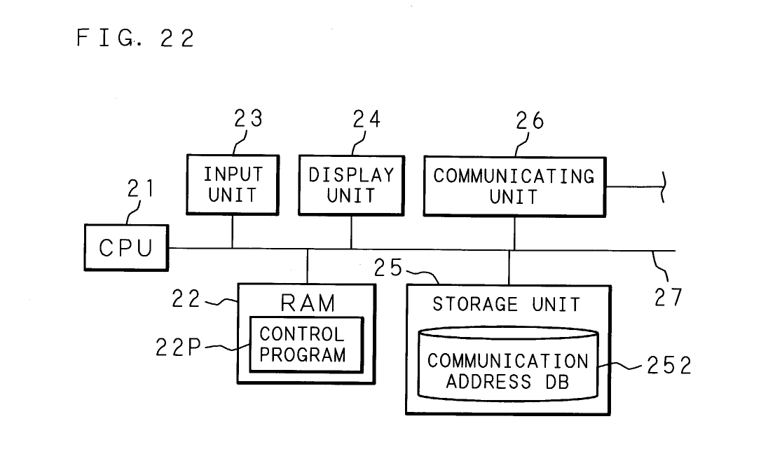

FIG. 22 is a block diagram showing the hardware structure of the server computer 2 of Fourth Embodiment. As shown in this figure, a CPU 21 is connected via a bus 27 to a RAM 22, a storage unit 25, a communicating unit 26 such as a gateway for transmitting/receiving information to/from the central apparatus 1, the information processor 3 and the like, a display unit 24, and an input unit 23. Loaded in the RAM 22 are a control program 22P for controlling the storage unit 25, the display unit 24, the input unit 23 and the like, a browser and the like.

The storage unit 25 possesses a communication address DB 252 which stores a name, a communication address and the like of a member who uses a carrier, i.e. a receiver of the present invention. FIG. 23 is an explanatory view showing the record layout of the communication address DB 252. The communication address DB 252 of the carrier stores an electronic mail address, a number of a portable telephone (hereinafter referred to as a portable telephone number) and a number of a home telephone (a fixed telephone) (hereinafter referred to as a home telephone number) in relation to an ID and the name of the member. A suitable communication address is selected in accordance with a designated desirable noticing method, and delivery noticing information is transmitted to the selected communication address.

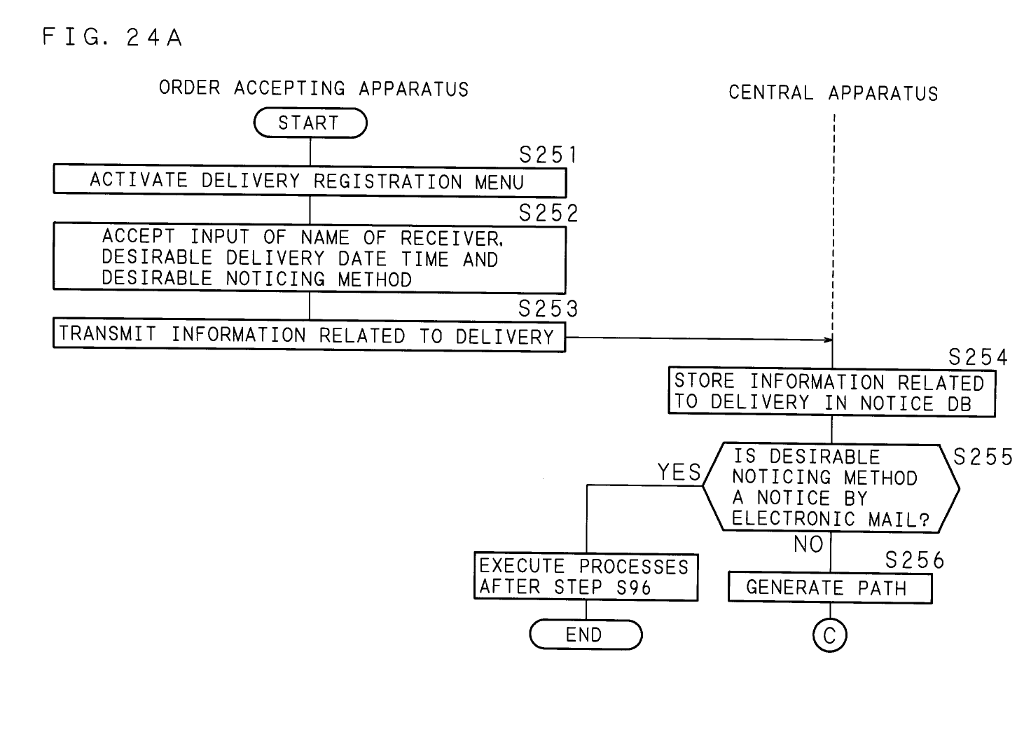

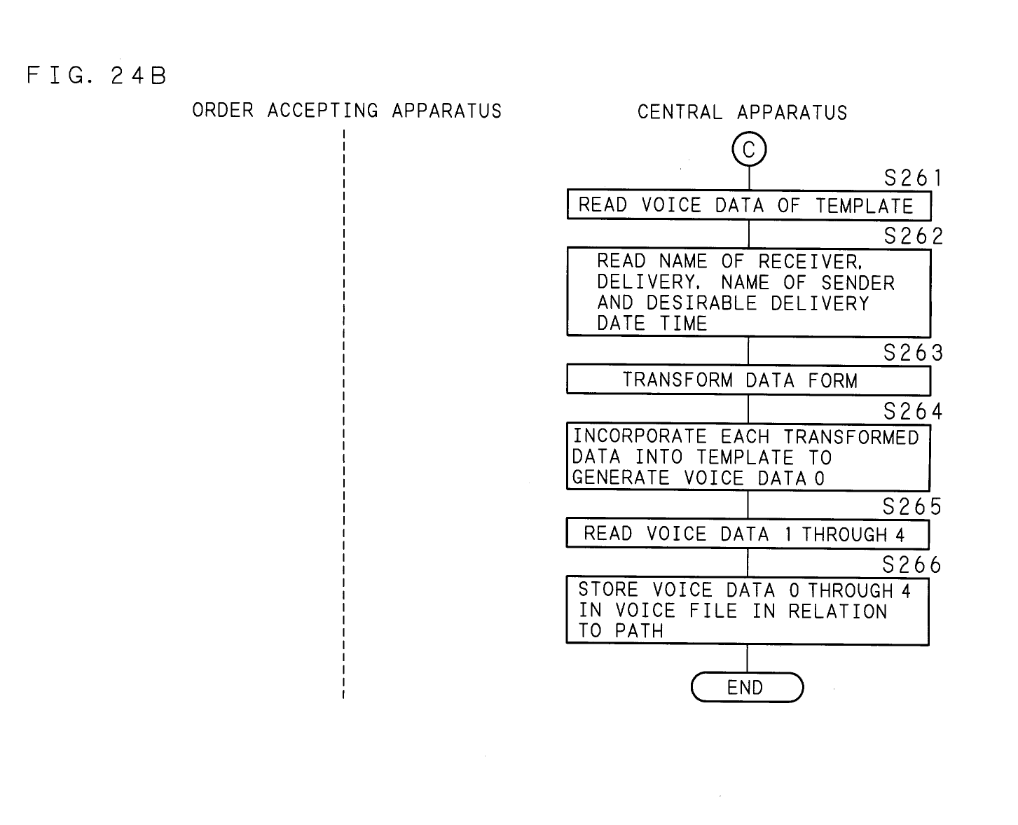

A processing procedure according to Fourth Embodiment in the above structure is hereinafter explained using flow charts. FIGS. 24A and 24B are flow charts showing a processing procedure executed between the order accepting apparatus 4 and the central apparatus 1. First, the delivery registration menu shown in FIG. 17 is activated at the order accepting apparatus 4 (step S251). When information related to a delivery such as the name of a receiver, a desirable delivery date time and a desirable noticing method is inputted through an input unit (unrepresented), the order accepting apparatus 4 accepts this information (step S252). The accepted information related to the delivery is transmitted to the central apparatus 1 (step S253).

When each order accepting apparatus 4 transmits information related to a delivery, the central apparatus 1 receives the information and then stores the information in the notice DB 152 (step S254). The central apparatus 1 then judges whether the desirable noticing method included in the transmitted information related to the delivery is a notice by electronic mail (step S255). In particular, the central apparatus 1 judges referring to a field for desirable noticing methods in the notice DB 152. When it is judged that the desirable noticing method is a notice by electronic mail (YES in the step S255), the central apparatus 1 executes processes after the step S96. The processes after the step S96, i.e. the procedure for giving a notice of delivery information by electronic mail, is described above in First Embodiment, and detailed explanation thereof is therefore omitted here.

When it is judged that the desirable noticing method is not a notice by electronic mail (NO in the step S255), the central apparatus 1 generates a unique path (step S256). It should be noted that this path indicates a storage area of voice data in the voice file 154. The path is generated in relation to the invoice number. The central apparatus 1 reads voice data of a template stored in the storage unit 15 and stores the data in the RAM 12 (step S261). The central apparatus 1 then reads the received information on the name of the receiver, a delivery, the name of the sender and a desirable delivery date time, and stores the information in the RAM 12 (step S262). The central apparatus 1 transforms the information on the name of a receiver, a delivery, the name of a sender and a desirable delivery date time which is text data into voice information, referring to an unrepresented text information/voice information translation table stored in the storage unit 15 (step S263).

The central apparatus 1 then incorporates each transformed voice data into voice data of a template in a predetermined order to generate voice data 0 which is to be transmitted to the server computer 2 (step S264). It should be noted that the voice data is generated in the WAV form or the like. Next, the central apparatus 1 reads voice data 1 through 4 of a template from the storage unit 15 (step S265). The central apparatus 1 then stores the generated voice data 0 and the read voice data 1 through 4 in the voice file 154 in relation to the generated path (step S266). This is the end of the process for generating delivery noticing information using voice guidance.

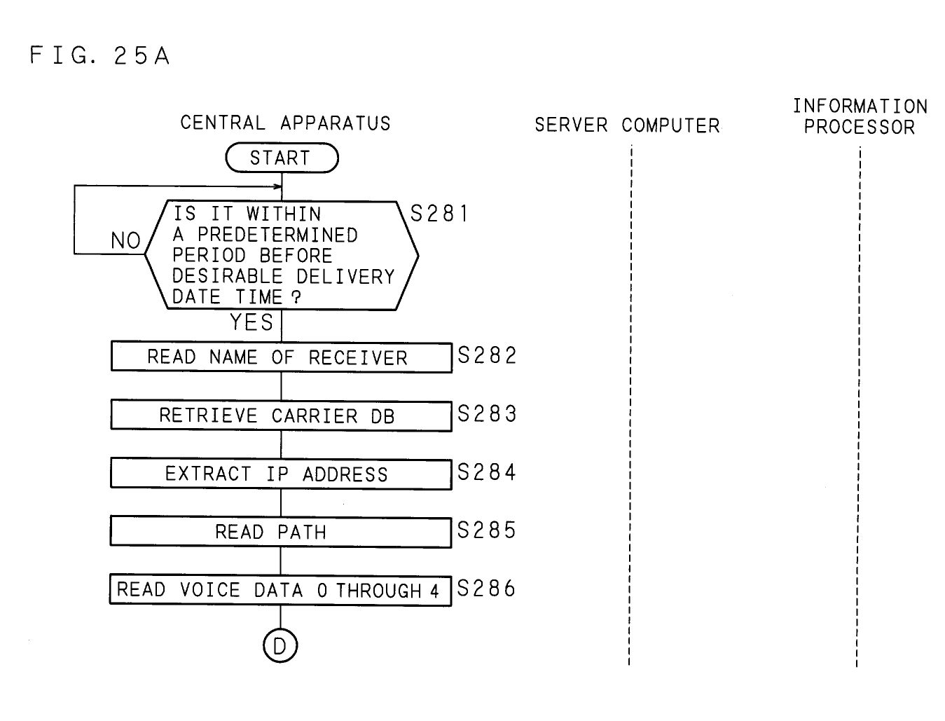

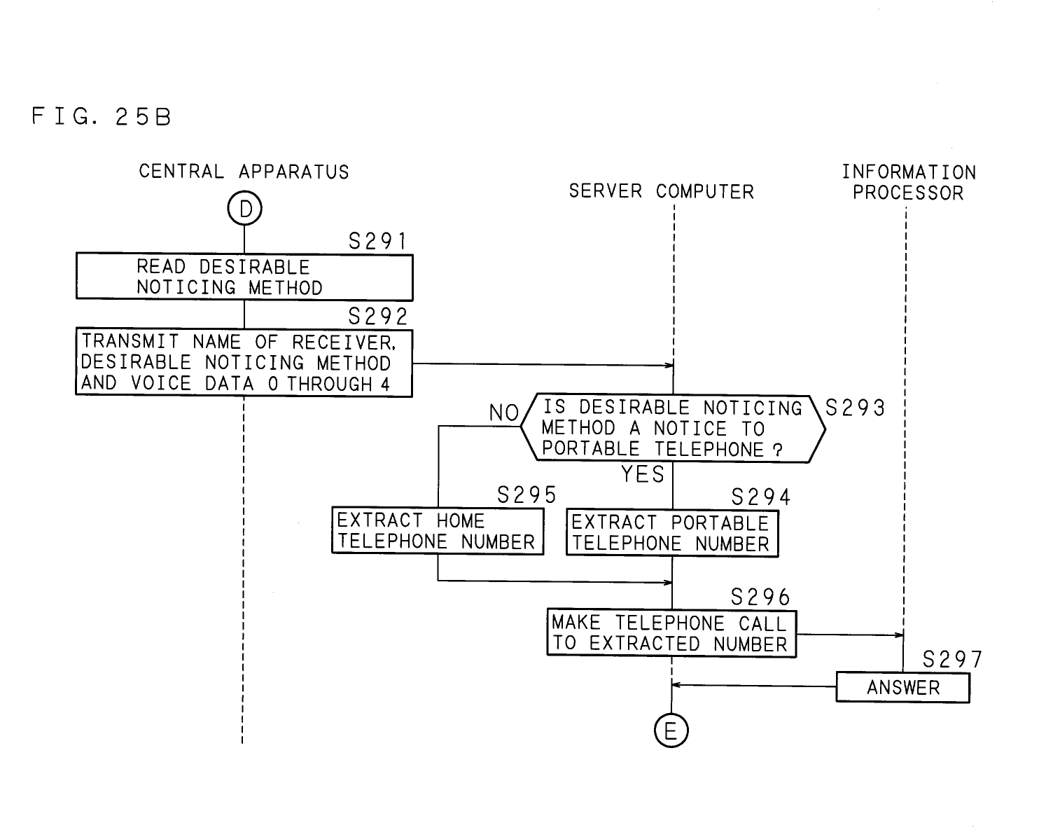

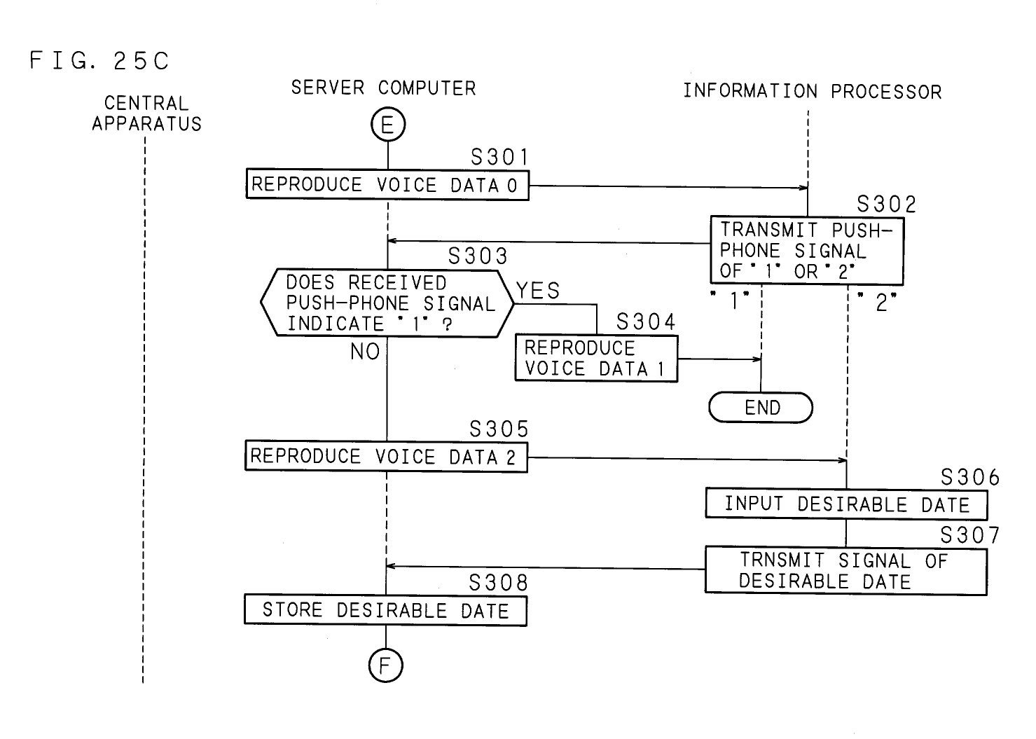

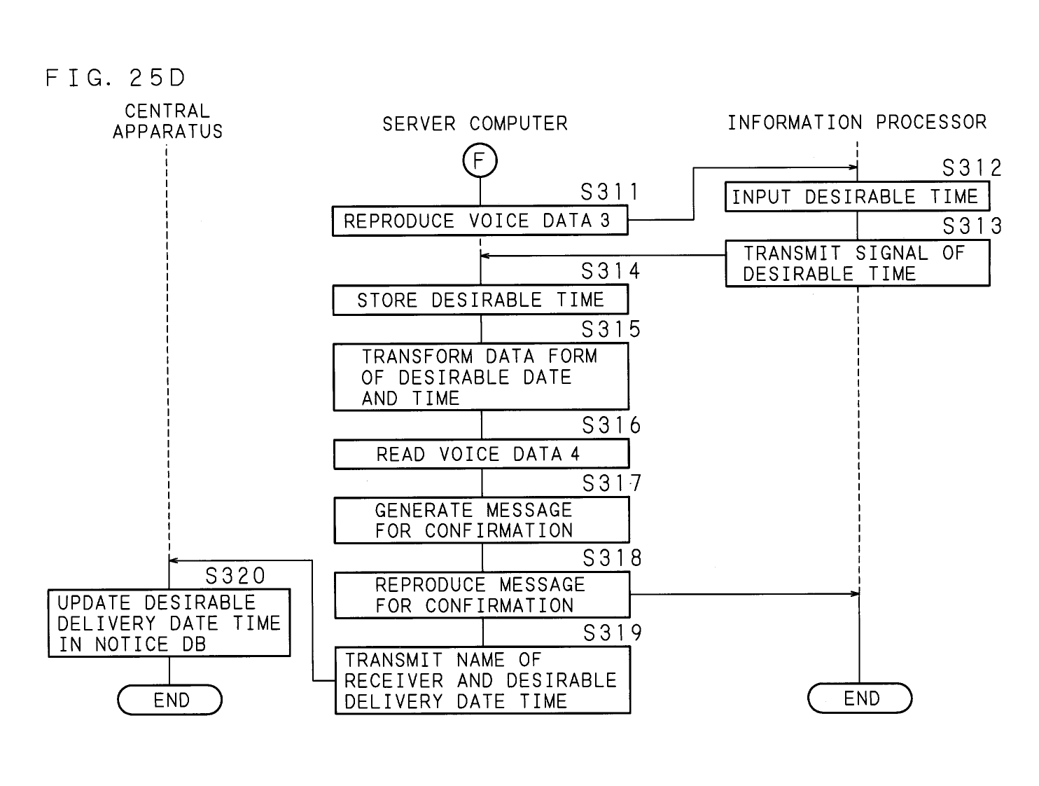

FIGS. 25A through 25D are flow charts showing an information processing procedure between the central apparatus 1, the server computer 2 and the information processor 3. First, the central apparatus 1 retrieves a field for desirable delivery date times in the notice DB 152, compares date time data outputted from an unrepresented timing unit with date time data in the field for desirable delivery date times, and judges whether it is within a predetermined period before the desirable delivery date time (step S281). When it is not within a predetermined period (NO in the step S281), the process is performed repeatedly. On the other hand, when it is within a predetermined period (YES in the step S281), the corresponding name of a receiver is read from a field for receivers in the notice DB 152 (step S282).

The central apparatus 1 retrieves a carrier DB 153 based on the read name of a receiver (step S283), and extracts an IP address of a server computer 2 of a corresponding carrier (step S284). The central apparatus 1 then reads a path corresponding to the name of the receiver which has been read from the notice DB 152 (step S285) and reads voice data 0 through 4 corresponding to the read path from the voice file 154 (step S286). The central apparatus 1 further retrieves a field for desirable noticing methods in the notice DB 152 and reads a desirable noticing method corresponding to the read name of the receiver (step S291).

After reading the desirable noticing method, the central apparatus 1 transmits the read name of the receiver, desirable noticing method and voice data 0 through 4 which is a delivery noticing information, to the corresponding server computer 2 referring to the read IP address (step S292). It should be noted that, though the present embodiment is constructed to generate the voice data 0 through 4 which is delivery noticing information at the central apparatus 1 and transmit the data to the server computer 2, the voice data 0 through 4 which is delivery noticing information may be generated in each server computer 2. The server computer 2 judges whether the transmitted desirable noticing method is a notice to a portable telephone (step S293). When the desirable noticing method is a notice to a portable telephone (YES in the step S293), the server computer 2 retrieves the communication address DB 252 based on the transmitted name of the receiver, and extracts a corresponding portable telephone number from a field for portable telephone numbers (step S294). On the other hand, when the desirable noticing method is not a notice to a portable telephone (NO in the step S293), the server computer 2 retrieves communication address DB 252 based on the transmitted name of the receiver, and extracts a corresponding home telephone number from a field for home telephone numbers (step S295).

The server computer 2 makes a telephone call to the information processor 3, based on the extracted home telephone number or portable telephone number (step S296). The receiver having the information processor 3 answers the telephone (step S297). When the receiver answers the telephone, the server computer 2 starts reproducing the voice data 0 (step S301). After listening to the voice data 0, the receiver pushes a button “1” when there is no change, or pushes a button “2” for changing the desirable delivery date time. A push-phone signal of “1” or “2” outputted in response to the button operation is transmitted to the server computer 2 (step S302). The server computer 2 judges whether the received push-phone signal indicates “1” (step S303).

When receiving a push-phone signal of “1” (YES in the step S303), the server computer 2 reproduces the voice data 1 (step S304). The receiver listens to a message for confirmation and ends the process. On the other hand, when receiving a push-phone signal of “2” and not “1” (NO in the step S303), the server computer 2 reproduces the voice data 2 (step S305). The receiver inputs a desirable date with push buttons according to guidance giving instructions to input a desirable date (step S306). A push-phone signal of the inputted desirable date is transmitted to the server computer 2 (step S307), and stored in the RAM 22 as a desirable date (step S308).

Next, the server computer 2 reproduces the voice data 3 (step S311). The receiver inputs a desirable time with push buttons according to guidance giving instructions to input a desirable time (step S312). A push-phone signal of the inputted 15 desirable time is transmitted to the server computer 2 (step S313), and stored in the RAM 22 as a desirable time (step S314). The server computer 2 reads the desirable date and time stored in the RAM 22, and transforms the data form into voice data (step S315). The server computer 2 then reads the voice data 4 (step S316) and 20 generates a message for confirmation by incorporating the voice data of the transformed desirable date time (step S317).

The generated message for confirmation is reproduced (step S318) and the receiver listens to the message to catch the changed desirable delivery date time. The server computer 2 transmits the 25 information on the name of the receiver and the information on a desirable date and time stored in the RAM 22, i.e. information on a desirable delivery date time, to the central apparatus 1 (step S319). The central apparatus 1 retrieves notice DB 152 based on the transmitted information on the name of the receiver, and updates the transmitted desirable delivery date time at a corresponding area in a field for desirable delivery date times (step S320). Since the present embodiment is constructed to realize a previous notice of delivery with voice guidance on telephone in addition to a notice by electronic mail, those who have trouble in using an electronic mail, such as aged people, can also easily use the service by the present system. Moreover, there is no need to notify delivery companies of a telephone number in addition to an electronic mail, and private information can therefore be protected suitably. It should be noted that it is not necessary to set noticing method for giving a previous notice of delivery in advance as described above. When a plurality of communication addresses of a receiver are stored, communication means may be selected in accordance with the situation, by at first using a home telephone or a portable and, when it is impossible to have a conversation with the receiver, giving a notice by electronic mail. Moreover, the priority for the communication means is not limited as above, and a notice on telephone may be given only when there is no response to the notice by electronic mail.

Since this Fourth Embodiment is constructed as above and other structures and functions are the same as those of First Embodiment through Third Embodiment, like reference numerals are used to refer to like parts and detailed explanation thereof are omitted here.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A delivery noticing method which gives a previous notice of delivery to a receiver, who receives a delivery, through a central apparatus for managing information related to the delivery including information on the receiver and a plurality of server computers of service providers, comprising the steps of:
storing in advance a receiver in relation to a service provider used by the receiver in service provider database;
accepting information related to a delivery by the central apparatus;
retrieving the service provider used by the receiver from the service provider database;
generating delivery noticing information based on the accepted information related to the delivery;
transmitting the generated delivery noticing information with information on the receiver from the central apparatus to a server computer of the retrieved service provider;
storing in advance a communication address of the receiver in relation to the receiver in address database which the server computer can access;
retrieving the communication address from the address database based on the transmitted information on the receiver; and
transmitting the transmitted delivery noticing information from the server computer to the retrieved communication address.

2. A delivery noticing method which gives a previous notice of delivery to a receiver, who receives a delivery, through a central apparatus for managing information related to the delivery including information on the receiver and a plurality of server computers of providers, comprising the steps of
storing in advance a receiver in relation to a provider used by the receiver in provider database;
accepting information related to a delivery excluding an electronic mail address of the receiver by the central apparatus;
retrieving the provider used by the receiver from the provider database;
generating delivery noticing information based on the accepted information related to the delivery;
transmitting the generated delivery noticing information with information on the receiver from the central apparatus to a server computer of the retrieved provider;
storing in advance an electronic mail address of the receiver in relation to the receiver in address database which the server computer can access;
retrieving the electronic mail address from the address database based on the transmitted information on the receiver; and
transmitting the transmitted delivery noticing information from the server computer to the retrieved electronic mail address.

3. A delivery noticing system for giving a previous notice of delivery to a receiver who receives a delivery, comprising:
a central apparatus for managing information related to a delivery including information on a receiver; and
a plurality of server computers of service providers, which are connected via a communication network to the central apparatus, wherein
the central apparatus includes a processor capable of performing the following operations:
storing a receiver in relation to a service provider used by the receiver in service provider database;
accepting information related to a delivery;
retrieving the service provider used by the receiver from the service provider database;
generating delivery noticing information based on the accepted information related to the delivery; and
transmitting the generated delivery noticing information with information on the receiver to a server computer of the retrieved service provider, wherein
the server computer includes a processor capable of performing the following operations:
storing a communication address of the receiver in relation to the receiver in address database;
retrieving the communication address from the address database based on the transmitted information on the receiver; and
transmitting the transmitted delivery noticing information to the retrieved communication address.

4. A delivery noticing system for giving a previous notice of delivery to a receiver who receives a delivery, comprising:
a central apparatus for managing information related to a delivery including information on a receiver; and
a plurality of server computers of service providers, which are connected via a communication network to the central apparatus, wherein
the central apparatus includes:
means for storing a receiver in relation to a service provider used by the receiver in service provider database;
means for accepting information related to a delivery;
means for retrieving the service provider used by the receiver from the service provider database;
means for generating delivery noticing information based on the accepted information related to the delivery; and
means for transmitting the generated delivery noticing information with information on the receiver to a server computer of the retrieved service provider, wherein
the server computer includes:
means for storing a communication address of the receiver in relation to the receiver in address database;
means for retrieving the communication address from the address database based on the transmitted information on the receiver; and
means for transmitting the transmitted delivery noticing information to the retrieved communication address.

5. A delivery noticing system for giving a previous notice of delivery to a receiver who receives a delivery, comprising:
a central apparatus for managing information related to a delivery including information on a receiver; and
a plurality of server computers of service providers, which are connected via a communication network to the central apparatus, wherein
the central apparatus includes a processor capable of performing the following operations:
storing a receiver in relation to a provider used by the receiver in provider database;
accepting information related to a delivery excluding an electronic mail address of the receiver;
retrieving the provider used by the receiver from the provider database;
generating delivery noticing information based on the accepted information related to the delivery; and
transmitting the generated delivery noticing information with information on the receiver to a server computer of the retrieved provider, wherein
the server computer includes a processor capable of performing the following operations:
storing an electronic mail address of the receiver in relation to the receiver in address database;
retrieving the electronic mail address from the address database based on the transmitted information on the receiver; and
transmitting the transmitted delivery noticing information to the retrieved electronic mail address.

6. The delivery noticing system according to claim 5, wherein the generating operation has the following operations:
storing the information related to the delivery in notice database; and
generating URL corresponding to the stored information related to the delivery as delivery noticing information.

7. A delivery noticing system for giving a previous notice of delivery to a receiver who receives a delivery, comprising:
a central apparatus for managing information related to a delivery including information on a receiver; and
a plurality of server computers of service providers, which are connected via a communication network to the central apparatus, wherein
the central apparatus includes a processor capable of performing the following operations:
storing a receiver in relation to a provider used by the receiver in provider database;
accepting information related to a delivery excluding an electronic mail address of the receiver;
retrieving the provider used by the receiver from the provider database; and
transmitting the information related to the delivery to a server computer of the retrieved provider, wherein
the server computer includes a processor capable of performing the following operations:
storing an electronic mail address of the receiver in relation to the receiver in address database;
generating delivery noticing information based on the transmitted information related to the delivery;
retrieving the electronic mail address from the address database based on information on the receiver included in the transmitted information related to the delivery; and
transmitting the generated delivery noticing information to the retrieved electronic mail address.

8. A central apparatus for managing information related to a delivery including information on a receiver who receives the delivery, comprising a processor capable of performing the following operations:
storing a receiver in relation to a service provider used by the receiver in service provider database;
accepting information related to a delivery;
retrieving the service provider used by the receiver from the service provider database;
generating delivery noticing information based on the accepted information related to the delivery; and
transmitting the generated delivery noticing information with information on the receiver to a server computer of the retrieved service provider.

9. A central apparatus for managing information related to a delivery including information on a receiver who receives the delivery, comprising:
means for storing a receiver in relation to a service provider used by the receiver in service provider database;
means for accepting information related to the delivery;
means for retrieving the service provider used by the receiver from the service provider database;
means for generating delivery noticing information based on the accepted information related to the delivery; and
means for transmitting the generated delivery noticing information with information on the receiver to a server computer of the retrieved service provider.

10. A central apparatus for managing information related to a delivery including information on a receiver who receives the delivery, comprising a processor capable of performing the following operations:
storing a receiver in relation to a provider used by the receiver in provider database;
accepting information related to a delivery excluding an electronic mail address of the receiver;
retrieving the provider used by the receiver from the provider database;
generating delivery noticing information based on the accepted information related to the delivery; and
transmitting the generated delivery noticing information with information on the receiver to a server computer of the retrieved provider.

11. A server computer for giving a previous notice of delivery to a receiver who receives a delivery, comprising a processor capable of performing the following operations:
storing a communication address of a receiver in relation to the receiver in address database;
retrieving the communication address from the address database based on information on the receiver transmitted from outside;
receiving delivery noticing information generated based on information related to the delivery, which is transmitted from outside; and
transmitting the received delivery noticing information to the retrieved communication address.

12. A server computer for giving a previous notice of delivery to a receiver who receives a delivery, comprising:
means for storing a communication address of a receiver in relation to the receiver in address database;
means for retrieving the communication address from the address database based on information on the receiver transmitted from outside;
means for receiving delivery noticing information generated based on information related to the delivery, which is transmitted from outside; and
means for transmitting the received delivery noticing information to the retrieved communication address.

13. A server computer for giving a previous notice of delivery to a receiver who receives a delivery, comprising a processor capable of performing the following operations:
storing an electronic mail address of a receiver in relation to the receiver in address database;
retrieving the electronic mail address from the address database based on information on the receiver transmitted from outside;
receiving delivery noticing information generated based on information related to the delivery excluding the electronic mail address, which is transmitted from outside; and
transmitting the received delivery noticing information to the retrieved electronic mail address.

14. A server computer for managing information related to a delivery including information on a receiver who receives the delivery and for giving a previous notice of delivery to the receiver, comprising a processor capable of performing the following operations:
storing a communication address of a receiver in relation to the receiver in address database;
accepting information related to a delivery;
generating delivery noticing information based on the accepted information related to the delivery;
retrieving the communication address from the address database based on information on the receiver included in the accepted information related to the delivery; and
transmitting the generated delivery noticing information to the retrieved communication address.

15. A server computer for managing information related to a delivery including information on a receiver who receives the delivery and for giving a previous notice of delivery to the receiver, comprising:
means for storing a communication address of a receiver in relation to the receiver in address database;
means for accepting information related to a delivery;
means for generating delivery noticing information based on the accepted information related to the delivery;
means for retrieving the communication address from the address database based on information on the receiver included in the accepted information related to the delivery; and
means for transmitting the generated delivery noticing information to the retrieved communication address.

16. A server computer for managing information related to a delivery including information on a receiver who receives the delivery and for giving a previous notice of delivery to the receiver, comprising a processor capable of performing the following operations:
storing an electronic mail address of a receiver in relation to the receiver in address database;
accepting information related to a delivery excluding an electronic mail address of the receiver;
generating delivery noticing information based on the accepted information related to the delivery;
retrieving the electronic mail address from the address database based on information on the receiver included in the accepted information related to the delivery; and
transmitting the generated delivery noticing information to the retrieved electronic mail address.

17. A recording medium which stores a computer program for managing information related to a delivery including information on a receiver who receives the delivery, the computer program comprising the steps of:
storing in advance a receiver in relation to a provider used by the receiver in provider database;
accepting information related to a delivery excluding an electronic mail address of the receiver;
retrieving the provider used by the receiver from the provider database;
generating delivery noticing information based on the accepted information related to the delivery; and
transmitting the generated delivery noticing information with information on the receiver to a server computer of the retrieved provider.

18. A recording medium which stores a computer program for giving a previous notice of delivery to a receiver who receives a delivery, the computer program comprising the steps of:
storing an electronic mail address of a receiver in relation to the receiver in address database;
retrieving the electronic mail address from the address database based on information on the receiver transmitted from outside;
receiving delivery noticing information generated based on information related to the delivery excluding the electronic mail address, which is transmitted from outside; and
transmitting the received delivery noticing information to the retrieved electronic mail address.

19. A recording medium which stores a computer program for managing information related to a delivery including information on a receiver who receives the delivery and for giving a previous notice of delivery to the receiver, the computer program comprising the steps of:
storing an electronic mail address of a receiver in relation to the receiver in address database;
accepting information related to a delivery excluding an electronic mail address of the receiver;
generating delivery noticing information based on the accepted information related to the delivery;
retrieving the electronic mail address from the address database based on information on the receiver included in the accepted information related to the delivery; and
transmitting the generated delivery noticing information to the retrieved electronic mail address.
